(19) United States
(12) Patent Application Publication
(10) Pub. No.: US 2024/0092337 A1
(43) Pub. Date: Mar. 21, 2024

(54) VEHICLE CONTROL APPARATUS

(71) Applicant: SUBARU CORPORATION, Tokyo (JP)

(72) Inventors: Hiroshi KUSANO, Tokyo (JP); Yoshinobu YAMAZAKI, Tokyo (JP); Masami OGURI, Tokyo (JP); Akihiro NABESHIMA, Tokyo (JP); Yoshiyuki JIN, Tokyo (JP); Takeshi YONEDA, Tokyo (JP); Fumiya SATO, Tokyo (JP); Keigo YAMADA, Tokyo (JP); Takumi ARAKI, Tokyo (JP); Shuntaro MIURA, Tokyo (JP)

(21) Appl. No.: 18/466,197

(22) Filed: Sep. 13, 2023

(30) Foreign Application Priority Data
Sep. 20, 2022 (JP) 2022-149062

(51) Int. Cl. B60W 10/119; B60K 1/02; B60K 1/04; B60L 58/22; B60W 10/08

(52) U.S. Cl. CPC B60W 10/119; B60K 1/02; B60K 1/04; B60L 58/22; B60W 10/08; B60L 7/10; B60L 2240/463; B60L 2240/54; B60W 2510/244; B60W 2710/083

(57) ABSTRACT

A vehicle control apparatus includes front-wheel and rear-wheel driving systems, and a control system. The front-wheel driving system includes a first travel motor mechanically coupled to a front wheel of a vehicle and a first accumulator electrically coupled to the first travel motor. The rear-wheel driving system includes a second travel motor mechanically coupled to a rear wheel of the vehicle and a second accumulator electrically coupled to the second travel motor. The control system includes one or more processors and one or more memories communicably coupled to the one or more processors, and controls the first and second travel motors. When a difference between an SOC of the first accumulator and an SOC of the second accumulator is greater than a threshold value, the one or more processors change a torque distribution ratio between the first and second travel motors from a reference distribution ratio.

### CROSS-REFERENCE TO RELATED APPLICATIONS

The present application claims priority from Japanese Patent Application No. 2022-149062 filed on Sep. 20, 2022, the entire contents of which are hereby incorporated by reference.

### BACKGROUND

The disclosure relates to a vehicle control apparatus to be applied to a vehicle.

As an electric vehicle or a hybrid vehicle, a vehicle has been developed that includes a driving electric motor for front wheels and a driving electric motor for rear wheels. For example, reference is made to Japanese Unexamined Patent Application Publication (JP-A) Nos. 2019-68680 and 2018-50388, and International Patent Application Publication WO 2020/184537. Providing the front wheels with the electric motor for the front wheels and providing the rear wheels with the electric motor for the rear wheels make it possible to freely control a torque distribution ratio between the front wheels and the rear wheels. This leads to enhancement of travel performance of the vehicle.

### SUMMARY

An aspect of the disclosure provides a vehicle control apparatus to be applied to a vehicle. The vehicle control apparatus includes a front-wheel driving system, a rear-wheel driving system, and a control system. The front-wheel driving system includes a first travel motor and a first accumulator. The first travel motor is mechanically coupled to a front wheel of the vehicle, and the first accumulator is electrically coupled to the first travel motor. The rear-wheel driving system includes a second travel motor and a second accumulator. The second travel motor is mechanically coupled to a rear wheel of the vehicle, and the second accumulator is electrically coupled to the second travel motor. The control system includes one or more processors and one or more memories communicably coupled to the one or more processors. The control system is configured to control the first travel motor and the second travel motor. The one or more processors are configured to, when a difference between a state of charge of the first accumulator and a state of charge of the second accumulator is greater than a threshold value, change a torque distribution ratio between the first travel motor and the second travel motor from a reference distribution ratio.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 illustrates a configuration example of a vehicle including a vehicle control apparatus according to an embodiment of the disclosure.

FIG. 2 is a block diagram illustrating an example of the vehicle control apparatus.

FIG. 3 is a block diagram illustrating an example of a basic structure of each control unit.

FIG. 4 is a flowchart illustrating an example of a procedure of carrying out a passive control.

FIG. 5 is a flowchart illustrating an example of the procedure of carrying out the passive control.

FIG. 6 illustrates an example of timing at which the passive control is carried out.

FIGS. 7A and 7B illustrate examples of a powering torque distribution ratio and a regenerative torque distribution ratio to be changed in the passive control.

FIG. 8 illustrates an example of changes in an SOCf and an SOCr before and after carrying out the passive control.

FIG. 9 illustrates an example of a degradation characteristic of a battery module.

FIG. 10 is a flowchart illustrating an example of a procedure of carrying out a condition determination control, part 1.

FIG. 11 is a timing chart illustrating an example of an execution state of the condition determination control, part 1.

FIG. 12 is a flowchart illustrating an example of a procedure of carrying out a condition determination control, part 2.

FIG. 13 is a flowchart illustrating an example of the procedure of carrying out the condition determination control, part 2.

FIG. 14 is a timing chart illustrating an example of an execution state of the condition determination control, part 2.

FIG. 15 is a timing chart illustrating an example of the execution state of the condition determination control, part 2.

FIG. 16 is a flowchart illustrating an example of a procedure of carrying out an active control.

FIG. 17 is a flowchart illustrating an example of the procedure of carrying out the active control.

FIG. 18 illustrates an example of changes in an accumulated amount of charge and an accumulated amount of discharge before and after carrying out the active control.

FIG. 19 illustrates an example of a correction coefficient that corrects a charge current and a discharge current.

FIG. 20A illustrates an example of an accumulation state of the charge current.

FIG. 20B illustrates an example of an accumulation state of the discharge current.

### DETAILED DESCRIPTION

It has been considered to couple a front-wheel battery to an electric motor for front wheels and couple a rear-wheel battery to an electric motor for rear wheels. However, separately mounting the front-wheel battery and the rear-wheel battery may possibly cause difficulties in continuing motor driving of the front wheels and the rear wheels. That is, when electric power of the front-wheel battery or the rear-wheel battery is depleted first, it is difficult to continue the motor driving by the depleted battery. Stopping the motor driving of the front wheels or the rear wheels causes degradation of travel performance of the vehicle. Thus, what is desired is to continue the motor driving of the front wheels and the rear wheels.

It is desirable to provide a vehicle control apparatus that makes it possible to continue motor driving of front wheels and rear wheels.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### <Vehicle>

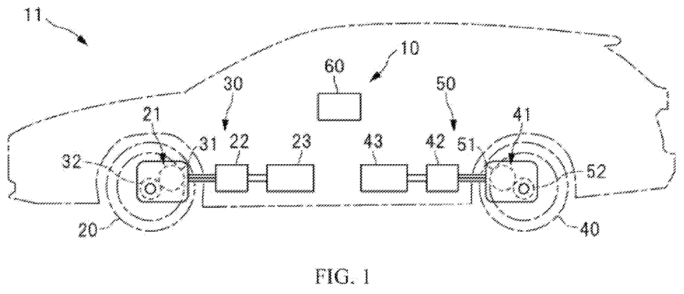

FIG. 1 illustrates a configuration example of a vehicle 11 including a vehicle control apparatus 10 according to an embodiment of the disclosure. As illustrated in FIG. 1, the vehicle 11 may include a front axle 21 and a rear axle 41. The front axle 21 may drive front wheels 20. The rear axle 41 may drive rear wheels 40. In the front axle 21, an electric motor may be incorporated. To the front axle 21, a front battery pack 23 may be coupled, with a front inverter 22 in between. The front axle 21, the front inverter 22, and the front battery pack 23 may constitute a front-wheel driving system 30 configured to drive the front wheels 20. Similarly, in the rear axle 41, an electric motor may be incorporated. To the rear axle 41, a rear battery pack 43 may be coupled, with a rear inverter 42 in between. The rear axle 41, the rear inverter 42, and the rear battery pack 43 may constitute a rear-wheel driving system 50 configured to driver the rear wheels 40.

### <Front-Wheel Driving System>

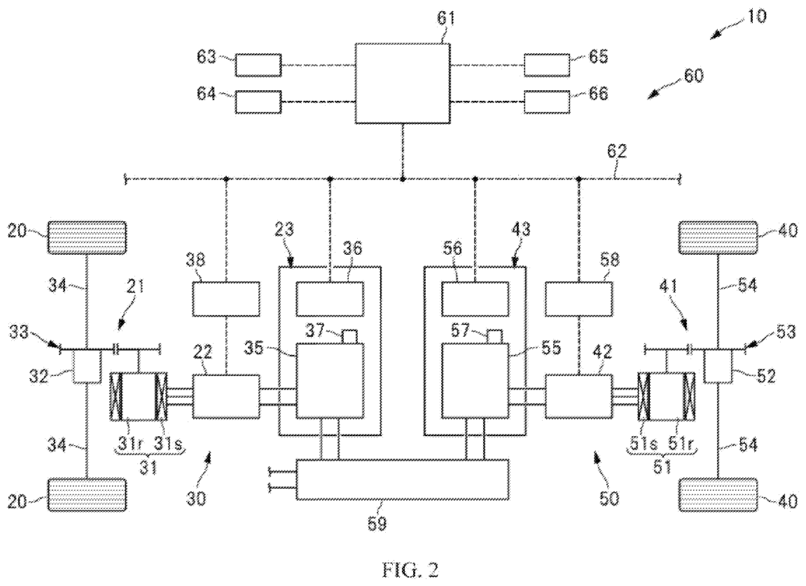

FIG. 2 illustrates an example of the vehicle control apparatus 10. As illustrated in FIG. 2, the front axle 21 of the front-wheel driving system 30 may include a front motor 31 and a front differential 32. In one embodiment of the disclosure, the front motor 31 may serve as a “first travel motor”. The front differential 32 is coupled to a rotor 31r of the front motor 31, with a gear train 33 in between. From the front differential 32, axles 34 extend. To the axles 34, the front wheels 20 are coupled. Thus, the front motor 31 of the front-wheel driving system 30 is mechanically coupled to the front wheels 20.

The front inverter 22 is coupled to a stator 31s of the front motor 31. The front battery pack 23 is coupled to the front inverter 22. The front battery pack 23 includes a battery module 35 including battery cells. In one embodiment of the disclosure, the battery module 35 may serve as a “first accumulator”. Thus, the battery module 35 of the front-wheel driving system 30 is electrically coupled to the front motor 31 as an electric motor. It is to be noted that the battery module 35 illustrated in the figure is a lithium-ion battery.

The front battery pack 23 may include a front battery control unit 36 and a battery sensor 37. The front battery control unit 36 may monitor charging and discharging of the battery module 35. The battery sensor 37 may detect, for example, charge and discharge currents and a terminal voltage. The front battery control unit 36 may calculate a state of charge (SOC), i.e., a charge state of the battery module 35, based on, for example, the charge and discharge currents and the terminal voltage detected by the battery sensor 37. The SOC of the battery module 35 is a ratio indicating a remaining amount of electricity accumulated in the battery module 35, and is a ratio of an amount of accumulated electricity to full charge capacity of the battery module 35. In the following description, the SOC of the battery module 35 provided in the front battery pack 23 is referred to as an “SOCf”.

The front battery control unit 36 may calculate an accumulated amount of charge Icf and an accumulated amount of discharge Idf of the battery module 35 based on the charge and discharge currents detected by the battery sensor 37. That is, the front battery control unit 36 may calculate the accumulated amount of charge Icf of the battery module 35 by accumulating the charge current of the battery module 35. The front battery control unit 36 may also calculate the accumulated amount of discharge Idf of the battery module 35 by accumulating the discharge current of the battery module 35.

As described later, in the battery module 35, three charge-and-discharge ranges R1 to R3 may be set. The front battery control unit 36 may calculate the accumulated amount of charge Icf and the accumulated amount of discharge Idf for each of the charge-and-discharge ranges R1 to R3. In one embodiment of the disclosure, the accumulated amount of charge Icf may serve as a “first accumulated amount of charge”, and the accumulated amount of discharge Idf may serve as a “first accumulated amount of discharge”. The accumulated amount of charge Icf is an amount of charge obtained by accumulating the charge current since the time of shipping from the factory. That is, the accumulated amount of charge Icf is an amount of charge [Ah] obtained by accumulating the charge current since when the battery module 35 is in a brand-new state. Similarly, the accumulated amount of discharge Idf is an amount of discharge obtained by accumulating the discharge current since the time of shipping from the factory. That is, the accumulated amount of discharge Idf is an amount of discharge [Ah] obtained by accumulating the discharge current since when the battery module 35 is in the brand-new state.

To control the front motor 31, a front motor control unit 38 may be coupled to the front inverter 22. The front motor control unit 38 may control the front inverter 22 to control an energization state of the stator 31s to control motor torque of the front motor 31. The front inverter 22 may include, for example, switching elements. The motor torque of the front motor 31 may include, for example, powering torque and regenerative torque. In controlling the front motor 31 to a powering state, electric power is supplied from the battery module 35 to the front motor 31. In controlling the front motor 31 to a regenerative state, i.e., a power generation state, electric power is supplied from the front motor 31 to the battery module 35.

### <Rear-Wheel Driving System>

As illustrated in FIG. 2, the rear axle 41 of the rear-wheel driving system 50 may include a rear motor 51 and a rear differential 52. In one embodiment of the disclosure, the rear motor 51 may serve as a “second travel motor”. The rear differential 52 is coupled to a rotor 51r of the rear motor 51, with a gear train 53 in between. From the rear differential 52, axles 54 extend. To the axles 54, the rear wheels 40 are coupled. Thus, the rear motor 51 of the rear-wheel driving system 50 is mechanically coupled to the rear wheels 40.

The rear inverter 42 is coupled to a stator 51s of the rear motor 51. The rear battery pack 43 is coupled to the rear inverter 42. The rear battery pack 43 includes a battery module 55 including battery cells. In one embodiment of the disclosure, the battery module 55 may serve as a “second accumulator”. Thus, the battery module 55 of the rear-wheel driving system 50 is electrically coupled to the rear motor 51 as an electric motor. It is to be noted that the battery module 55 illustrated in the figure is a lithium-ion battery.

The rear battery pack 43 may include a rear battery control unit 56 and a battery sensor 57. The rear battery control unit 56 may monitor charging and discharging of the battery module 55. The battery sensor 57 may detect, for example, charge and discharge currents and a terminal voltage. The rear battery control unit 56 may calculate an SOC, i.e., a charge state of the battery module 55, based on, for example, the charge and discharge currents and the terminal voltage detected by the battery sensor 57. The SOC of the battery module 55 is a ratio indicating a remaining amount of electricity accumulated in the battery module 55, and is a ratio of an amount of accumulated electricity to full charge capacity of the battery module 55. In the following description, the SOC of the battery module 55 provided in the rear battery pack 43 is referred to as an “SOCr”.

The rear battery control unit 56 may calculate an accumulated amount of charge Icr and an accumulated amount of discharge Idr of the battery module 55 based on the charge and discharge currents detected by the battery sensor 57. That is, the rear battery control unit 56 may calculate the accumulated amount of charge Icr of the battery module 55 by accumulating the charge current of the battery module 55. The rear battery control unit 56 may also calculate the accumulated amount of discharge Idr of the battery module 55 by accumulating the discharge current of the battery module 55.

As described later, in the battery module 55, the three charge-and-discharge ranges R1 to R3 may be set. The rear battery control unit 56 may calculate the accumulated amount of charge Icr and the accumulated amount of discharge Idr for each of the charge-and-discharge ranges R1 to R3. In one embodiment of the disclosure, the accumulated amount of charge Icr may serve as a “second accumulated amount of charge”, and the accumulated amount of discharge Idr may serve as a “second accumulated amount of discharge”. The accumulated amount of charge Icr is an amount of charge obtained by accumulating the charge current since the time of shipping from the factory. That is, the accumulated amount of charge Icr is an amount of charge [Ah] obtained by accumulating the charge current since when the battery module 55 is in the brand-new state. Similarly, the accumulated amount of discharge Idr is an amount of discharge obtained by accumulating the discharge current since the time of shipping from the factory. That is, the accumulated amount of discharge Idr is an amount of discharge [Ah] obtained by accumulating the discharge current since when the battery module 55 is in the brand-new state.

To control the rear motor 51, a rear motor control unit 58 may be coupled to the rear inverter 42. The rear motor control unit 58 may control the rear inverter 42 to control an energization state of the stator 51s to control motor torque of the rear motor 51. The rear inverter 42 may include, for example, switching elements. The motor torque of the rear motor 51 may include, for example, powering torque and regenerative torque. In controlling the rear motor 51 to a powering state, electric power is supplied from the battery module 55 to the rear motor 51. In controlling the rear motor 51 to a regenerative state, i.e., a power generation state, electric power is supplied from the rear motor 51 to the battery module 55.

To the front battery pack 23 and the rear battery pack 43, an in-vehicle charger 59 may be coupled. The in-vehicle charger 59 may charge the battery modules 35 and 55 with the use of an unillustrated external power supply.

### <Control System>

As illustrated in FIG. 2, the vehicle control apparatus 10 includes a control system 60, to control the front-wheel driving system 30 and the rear-wheel driving system 50. The control system 60 may include electronic control units. The electronic control units constituting the control system 60 may include, for example, the front battery control unit 36, the front motor control unit 38, the rear battery control unit 56, and the rear motor control unit 58 described above. The electronic control units constituting the control system 60 may further include, for example, a vehicle control unit 61. The vehicle control unit 61 may output control signals to the control units 36, 38, 56, and 58 described above.

The control units 36, 38, 56, 58, and 61 constituting the control system 60 may be communicably coupled to one another through an in-vehicle network 62 such as a controlled area network (CAN). The vehicle control unit 61 may set operation targets of, for example, the front motor 31 and the rear motor 51, based on data inputted from the various control units and various sensors described later. The vehicle control unit 61 may generate the control signals corresponding to the operation targets of, for example, the front motor 31 and the rear motor 51. The vehicle control unit 61 may output the control signals to the front motor control unit 38 and the rear motor control unit 58.

The sensors coupled to the vehicle control unit 61 may include, for example, a vehicle speed sensor 63, an accelerator sensor 64, and a brake sensor 65. The vehicle speed sensor 63 may detect a vehicle speed, i.e., a travel speed of the vehicle 11. The accelerator sensor 64 may detect an operation state of an accelerator pedal. The brake sensor 65 may detect an operation state of a brake pedal. To the vehicle control unit 61, a start switch 66 may be further coupled. The start switch 66 may be operated by a driver at a start-up of the control system 60.

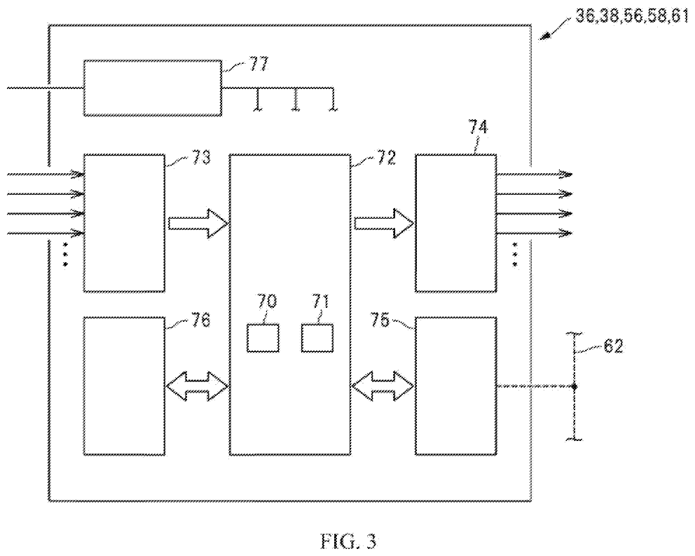

FIG. 3 illustrates an example of a basic structure of each of the control units 36, 38, 56, 58, and 61. As illustrated in FIG. 3, the control unit as an electronic control unit may include a microcontroller 72 in which, for example, a processor 70 and a main memory 71 are incorporated. In one embodiment of the disclosure, the processor 70 may serve as “one or more processors”, and the main memory 71 may server as “one or more memories”. The main memory 71 may hold predetermined programs, and the processor 70 may execute the programs. The processor 70 and the main memory 71 may be communicably coupled to each other. It is to be noted that multiple processors 70 may be incorporated in the microcontroller 72, and multiple main memories 71 may be incorporated in the microcontroller 72.

The control unit may further include, for example, an input circuit 73, a drive circuit 74, a communication circuit 75, an external memory 76, and a power supply circuit 77. The input circuit 73 may convert signals inputted from the various sensors into signals suppliable to the microcontroller 72. The drive circuit 74 may generate drive signals for various devices such as the inverters 22 and 42 described above, based on signals outputted from the microcontroller 72. The communication circuit 75 may convert the signals outputted from the microcontroller 72 into communication signals directed to the other control units. The communication circuit 75 may also convert communication signals received from the other control units into signals suppliable to the microcontroller 72. The power supply circuit 77 may supply a stable power supply voltage to, for example, the microcontroller 72, the input circuit 73, the drive circuit 74, the communication circuit 75, and the external memory 76. The external memory 76 may include, for example, a nonvolatile memory. The external memory 76 may hold, for example, programs and various pieces of data.

### <Passive Control>

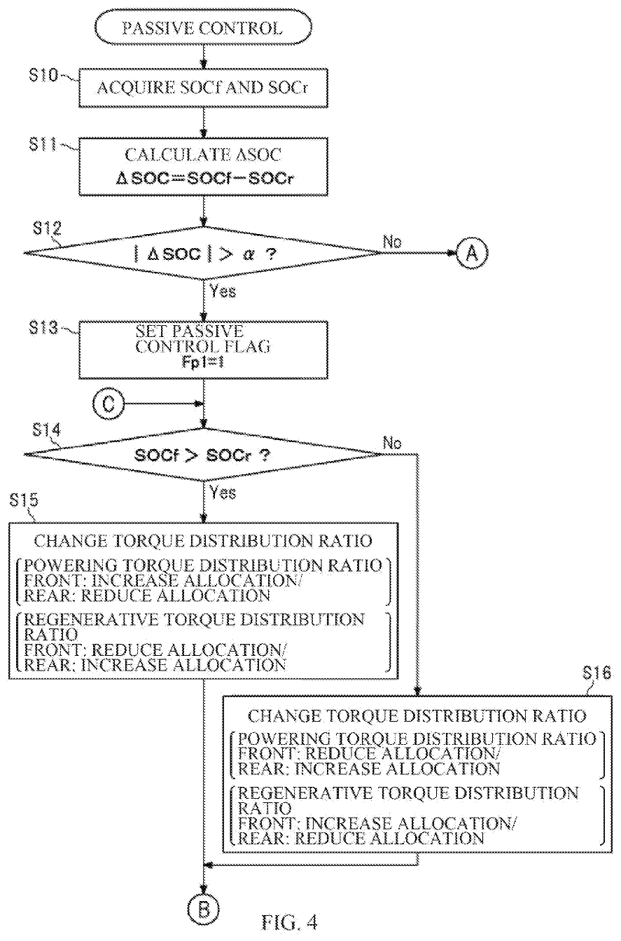

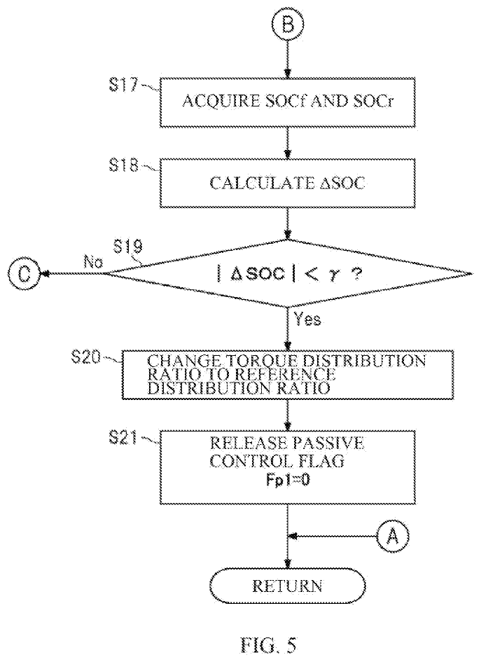

Description is given next of a passive control, i.e., an SOC equalization control to bring the SOCf and the SOCr of the battery module 35 close to each other. FIGS. 4 and 5 are flowcharts illustrating an example of a procedure of carrying out the passive control. It is to be noted that the flowcharts illustrated in FIGS. 4 and 5 are coupled to each other at positions denoted by reference characters A, B, and C. Each step of the passive control illustrated in FIGS. 4 and 5 illustrates a process to be carried out by the processor 70 constituting the control system 60. The passive control illustrated in FIGS. 4 and 5 is a control to be carried out by the control system 60 at predetermined intervals after the start-up of the control system 60.

As illustrated in FIG. 4, in step S10, the SOCf of the battery module 35 and the SOCr of the battery module 55 may be read. Thereafter, in step S11, the SOCr may be subtracted from the SOCf to calculate ΔSOC, i.e., a difference in the SOC. Thereafter, in step S12, it may be determined whether or not an absolute value of ΔSOC is greater than a predetermined starting threshold value α. In one embodiment of the disclosure, the predetermined starting threshold value α may serve as a “threshold value”. In step S12, when it is determined that the absolute value of ΔSOC is greater than the starting threshold value α (Yes in step S12), that is, when it is determined that the SOCf and the SOCr are deviated from each other, the flow may proceed to step S13. In step S13, a passive control flag Fp1 may be set (Fp1=1). The passive control flag Fp1 indicates that the passive control is to be carried out.

Thereafter, in step S14, it may be determined whether or not the SOCf is greater than the SOCr. In step S14, when it is determined that the SOCf is greater than the SOCr (Yes in step S14), the SOCf of the front battery module 35 is excessively high, and the flow may proceed to step S15. In step S15, a torque distribution ratio between the front motor 31 and the rear motor 51 may be changed from a predetermined reference distribution ratio. That is, the torque distribution ratio between the front motor 31 and the rear motor 51 may be changed from the reference distribution ratio to promote the discharging of the front battery module 35 to lower the SOCf, and to promote the charging of the rear battery module 55 to raise the SOCr.

Here, the reference distribution ratio is a torque distribution ratio between the front motor 31 and the rear motor 51 set in advance for each vehicle model. For example, when the reference distribution ratio between the front and rear is set to “50:50”, in setting target motor torque from a requested driving force based on, for example, an accelerator operation, the motor torque of the front motor 31 and the motor torque of the rear motor 51 are controlled to have the same value. For example, when the reference distribution ratio between the front and rear is set to “40:60” biased to the rear wheels, in setting the target motor torque from the requested driving force based on, for example, the accelerator operation, the motor torque of the rear motor 51 is controlled to be greater by 20% than the motor torque of the front motor 31. For example, when the reference distribution ratio between the front and rear is set to “60:40” biased to the front wheels, in setting the target motor torque from the requested driving force based on, for example, the accelerator operation, the motor torque of the front motor 31 is controlled to be greater by 20% than the motor torque of the rear motor 51. It is to be noted that the reference distribution ratio may be a fixed torque distribution ratio, or alternatively, the reference distribution ratio may be a torque distribution ratio that varies with a travel situation. Moreover, the reference distribution ratio related to the powering torque and the reference distribution ratio related to the regenerative torque may be distribution ratios that coincide with each other, or may be distribution ratios that are different from each other.

In step S15, the torque distribution ratio between the front motor 31 and the rear motor 51 may be changed from the reference distribution ratio, to promote the discharging of the front battery module 35 to lower the SOCf. That is, the powering torque distribution ratio may be changed to be biased to the front wheels, to increase the powering torque to be allocated to the front motor 31 to a greater value than the powering torque to be allocated based on the reference distribution ratio, and to reduce the powering torque to be allocated to the rear motor 51 to a smaller value than the powering torque to be allocated based on the reference distribution ratio. This makes it possible to promote the discharging of the front battery module 35 to promote a decrease in the SOCf, and to suppress the discharging of the rear battery module 55 to suppress a decrease in the SOCr. That is, powering states of the front motor 31 and the rear motor 51 on accelerated travel and steady travel are controlled to bring the SOCf and the SOCr closer to each other. The powering torque to be allocated to the front motor 31 means a target value of the powering torque to be allocated to the front motor 31, i.e., target powering torque to be allocated to the front motor 31. Similarly, the powering torque to be allocated to the rear motor 51 means a target value of the powering torque to be allocated to the rear motor 51, i.e., target powering torque to be allocated to the rear motor 51.

Moreover, in step S15, the torque distribution ratio between the front motor 31 and the rear motor 51 may be changed from the reference distribution ratio, to promote the charging of the rear battery module 55 to raise the SOCr. That is, the regenerative torque distribution ratio may be changed to be biased to the rear wheels, to reduce the regenerative torque to be allocated to the front motor 31 to a smaller value than the regenerative torque to be allocated based on the reference distribution ratio, and to increase the regenerative torque to be allocated to the rear motor 51 to a greater value than the regenerative torque to be allocated based on the reference distribution ratio. This makes it possible to suppress the charging of the front battery module 35 to suppress an increase in the SOCf, and to promote the charging of the rear battery module 55 to promote an increase in the SOCr. That is, regenerative states of the front motor 31 and the rear motor 51 on decelerated travel are controlled to bring the SOCf and the SOCr closer to each other. The regenerative torque to be allocated to the front motor 31 means a target value of the regenerative torque to be allocated to the front motor 31, i.e., target regenerative torque to be allocated to the front motor 31. Similarly, the regenerative torque to be allocated to the rear motor 51 means a target value of the regenerative torque to be allocated to the rear motor 51, i.e., target regenerative torque to be allocated to the rear motor 51.

Meanwhile, in step S14, when it is determined that the SOCf is smaller than the SOCr (No in step S14), the SOCr of the rear battery module 55 is excessively high, and the flow may proceed to step S16. In step S16, the torque distribution ratio between the front motor 31 and the rear motor 51 may be changed from the predetermined reference distribution ratio. That is, the torque distribution ratio between the front motor 31 and the rear motor 51 may be changed from the reference distribution ratio, to promote the charging of the front battery module 35 to raise the SOCf, and to promote the discharging of the rear battery module 55 to lower the SOCr.

In step S16, the torque distribution ratio between the front motor 31 and the rear motor 51 may be changed from the reference distribution ratio, to promote the discharging of the rear battery module 55 to lower the SOCr. In other words, the powering torque distribution ratio may be changed to be biased to the rear wheels, to reduce the powering torque to be allocated to the front motor 31 to a smaller value than the powering torque to be allocated based on the reference distribution ratio, and to increase the powering torque to be allocated to the rear motor 51 to a greater value than the powering torque to be allocated based on the reference distribution ratio. This makes it possible to suppress the discharging of the front battery module 35 to suppress the decrease in the SOCf, and to promote the discharging of the rear battery module 55 to promote the decrease in the SOCr. That is, the powering states of the front motor 31 and the rear motor 51 on the accelerated travel and the steady travel are controlled to bring the SOCf and the SOCr closer to each other.

Moreover, in step S16, the torque distribution ratio between the front motor 31 and the rear motor 51 may be changed from the reference distribution ratio, to promote the charging of the front battery module 35 to raise the SOCf. That is, the regenerative torque distribution ratio may be changed to be biased to the front wheels, to increase the regenerative torque to be allocated to the front motor 31 to a greater value than the regenerative torque to be allocated based on the reference distribution ratio, and to reduce the regenerative torque to be allocated to the rear motor 51 to a smaller value than the regenerative torque to be allocated based on the reference distribution ratio. This makes it possible to promote the charging of the front battery module 35 to promote the increase in the SOCf, and to suppress the charging of the rear battery module 45 to suppress the increase in the SOCr. That is, the regenerative states of the front motor 31 and the rear motor 51 on the deceleration travel are controlled to bring the SOCf and the SOCr closer to each other.

Thereafter, as illustrated in FIG. 5, in step S17, the SOCf and the SOCr may be read. In step S18, the SOCr may be subtracted from the SOCf to calculate ΔSOC. Thereafter, in step S19, it may be determined whether or not the absolute value of ΔSOC is smaller than an end threshold value γ. The end threshold value γ is smaller than the starting threshold value α. In step S19, when it is determined that the absolute value of ΔSOC is smaller than the end threshold value γ (Yes in step S19), that is, when it is determined that ΔSOC has been eliminated, the flow may proceed to step S20. In step S20, the torque distribution ratios for the powering torque and the regenerative torque may be restored to the reference distribution ratio, and the flow may proceed to step S21. In step S21, the passive control flag Fp1 may be released (Fp1=0).

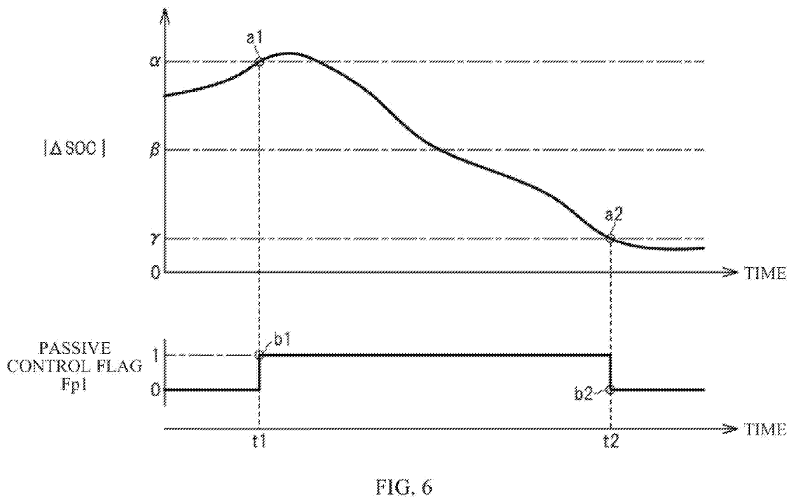

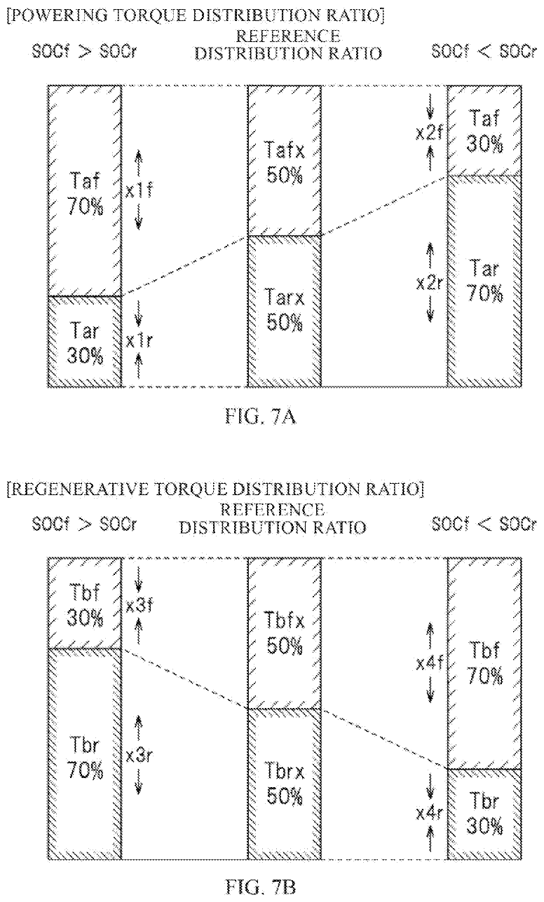

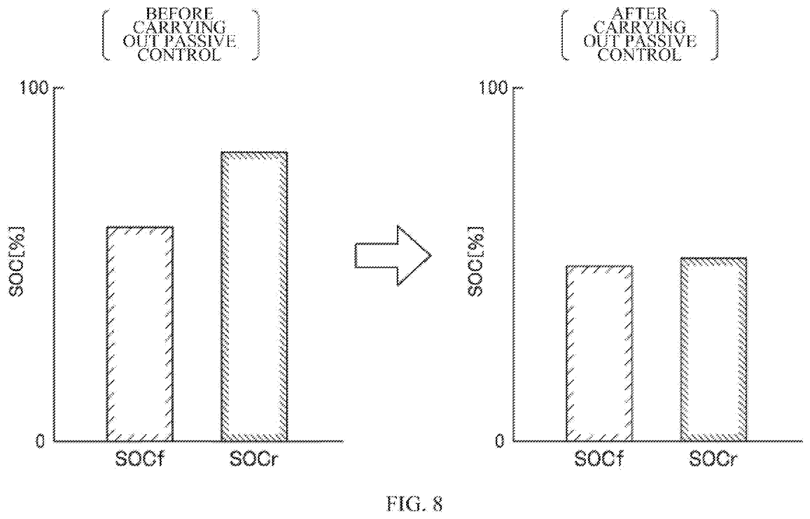

FIG. 6 illustrates an example of timing at which the passive control is carried out. FIGS. 7A and 7B illustrate examples of the powering torque distribution ratio and the regenerative torque distribution ratio to be changed in the passive control. FIG. 8 illustrates an example of the changes in the SOCf and the SOCr before and after carrying out the passive control. In FIGS. 7A and 7B, the reference characters “Taf” and “Tafx” denote the powering torque to be allocated to the front motor 31. The reference characters “Tar” and “Tarx” denote the powering torque to be allocated to the rear motor 51. The reference characters “Tbf” and “Tbfx” denote the regenerative torque to be allocated to the front motor 31. The reference characters “Tbr” and “Tbrx” denote the regenerative torque to be allocated to the rear motor 51.

As denoted by the time t1 in FIG. 6, when ΔSOC as the difference between the SOCf and the SOCr becomes greater than the starting threshold value α (reference characters a1), the passive control flag Fp1 is set and the passive control is started (reference characters b1). Thereafter, ΔSOC is gradually decreased by changing the torque distribution ratio from the reference distribution ratio. As denoted by the time t2, when ΔSOC becomes smaller than the end threshold value γ (reference characters a2), the passive control flag Fp1 is released and the passive control is ended (reference characters b2). That is, the torque distribution ratio that has been changed by the passive control is restored to the reference distribution ratio.

Moreover, as denoted by arrows x1f and x1r in FIG. 7A, when the SOCf becomes greater than the SOCr in the passive control, the powering torque Taf to be allocated to the front motor 31 is increased to a greater value than the powering torque Tafx to be allocated based on the reference distribution ratio (arrow x1f), and the powering torque Tar to be allocated to the rear motor 51 is reduced to a smaller value than the powering torque Tarx to be allocated based on the reference distribution ratio (arrow x1r). This makes it possible to promote the discharging of the front battery module 35 to promote the decrease in the SOCf, and to suppress the discharging of the rear battery module 55 to suppress the decrease in the SOCr. Accordingly, as illustrated in FIG. 8, it is possible to bring the SOCf and the SOCr closer to each other.

As denoted by arrows x2f and x2r in FIG. 7A, when the SOCf becomes smaller than the SOCr in the passive control, the powering torque Taf to be allocated to the front motor 31 is reduced to a smaller value than the powering torque Tafx to be allocated based on the reference distribution ratio (arrow x2f), and the powering torque Tar to be allocated to the rear motor 51 is increased to a greater value than the powering torque Tarx to be allocated based on the reference distribution ratio (arrow x2r). This makes it possible to suppress the discharging of the front battery module 35 to suppress the decrease in the SOCf, and to promote the discharging of the rear battery module 55 to promote the decrease in the SOCr. Accordingly, as illustrated in FIG. 8, it is possible to bring the SOCf and the SOCr closer to each other.

As denoted by arrows x3f and x3r in FIG. 7B, when the SOCf becomes greater than the SOCr in the passive control, the regenerative torque Tbf to be allocated to the front motor 31 is reduced to a smaller value than the regenerative torque Tbfx to be allocated based on the reference distribution ratio (arrow x3f), and the regenerative torque Tbr to be allocated to the rear motor 51 is increased to a greater value than the regenerative torque Tbrx to be allocated based on the reference distribution ratio (arrow x3r). This makes it possible to suppress the charging of the front battery module 35 to suppress the increase in the SOCf, and to promote the charging of the rear battery module 55 to promote the increase in the SOCr. Accordingly, as illustrated in FIG. 8, it is possible to bring the SOCf and the SOCr closer to each other.

As denoted by arrows x4f and x4r in FIG. 7B, when the SOCf becomes smaller than the SOCr in the passive control, the regenerative torque Tbf to be allocated to the front motor 31 is increased to a greater value than the regenerative torque Tbfx to be allocated based on the reference distribution ratio (arrow x4f), and the regenerative torque Tbr to be allocated to the rear motor 51 is reduced to a smaller value than the regenerative torque Tbrx to be allocated based on the reference distribution ratio (arrow x4r). This makes it possible to promote the charging of the front battery module 35 to promote the increase in the SOCf, and to suppress the charging of the rear battery module 55 to suppress the increase in the SOCr. Accordingly, as illustrated in FIG. 8, it is possible to bring the SOCf and the SOCr closer to each other.

As described, carrying out the passive control makes it possible to bring the SOCf of the front battery module 35 and the SOCr of the rear battery module 55 closer to each other. Hence, it is possible to lower the SOCf and the SOCr substantially equally during the travel of the vehicle 11, leading to long-time continuation of motor driving of the front wheels 20 and the rear wheels 40. That is, it is possible to continue the motor driving of the front wheels 20 and the rear wheels 40 for long time without excessively lowering only either the SOCf or the SOCr.

### <Degradation Characteristics of Battery Module>

As described, the battery modules 35 and 55 in the figure are lithium-ion batteries that cause movements of lithium ions between positive and negative electrodes in accordance with the charging and discharging. The battery modules 35 and 55 include lithium-containing oxides as a positive electrode active material, and graphite or silicon having a layered structure as a negative electrode active material.

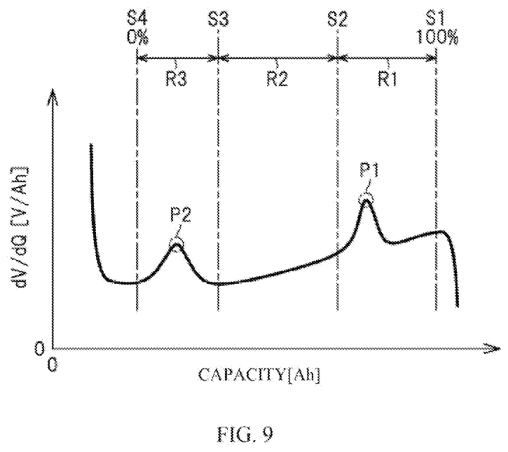

FIG. 9 illustrates an example of degradation characteristics of the battery modules 35 and 55. FIG. 9 illustrates a dV/dQ curve of the battery modules 35 and 55. The dV/dQ curve is a curve obtained by differentiating a voltage V in a discharge curve of the battery modules 35 and 55 by a capacity Q. As illustrated in FIG. 9, a capacity at which the layered structure in the negative electrode active material greatly changes because of expansion and contraction during the charging and discharging is detectable as peaks P1 and P2 of the dV/dQ curve. That is, the charging and discharging at and around the peaks P1 and P2 are factors that cause degradation of the battery modules 35 and 55, as compared with the charging and discharging in other regions. As described, the battery modules 35 and 55 have different degradation characteristics for each capacity at which the charging and discharging is carried out.

As illustrated in FIG. 9, in the battery modules 35 and 55, four boundary values S1 to S4 relating to the capacity may be set. Moreover, in the battery modules 35 and 55, the three charge-and-discharge ranges R1 to R3 may be set between the boundary value S1 and the boundary value S4. In one embodiment of the disclosure, the three charge-and-discharge ranges R1 to R3 may serve as “charge-and-discharge ranges”. In one embodiment of the disclosure, the boundary value S1 may serve as an “upper limit state of charge”, and the boundary value S4 may serve as a “lower limit state of charge”. In other words, in the battery modules 35 and 55, the charge-and-discharge ranges R1 to R3 may be set. The charge-and-discharge range R1 is separated by the boundary value S1 and a boundary value S2. The charge-and-discharge range R2 is separated by the boundary value S2 and a boundary value S3. The charge-and-discharge range R3 is separated by the boundary values S3 and S4. The boundary value S1 means a capacity at which the SOC is calculated as 100%, i.e., an upper limit capacity in charging the battery modules 35 and 55. The boundary value S4 means a capacity at which the SOC is calculated as 0%, i.e., a lower limit capacity in allowing the battery modules 35 and 55 to discharge.

As illustrated in FIG. 9, the charge-and-discharge range R1 includes the peak P1 of the dV/dQ curve, and the charge-and-discharge range R3 includes the peak P2 of the dV/dQ curve. That is, even when an amount of charge and discharge are the same, the charging and discharging in the charge-and-discharge ranges R1 and R3 is a factor that causes the degradation of the battery modules 35 and 55, as compared with the charging and discharging in the charge-and-discharge range R2. As described, the battery modules 35 and 55 have different degradation characteristics for each of the charge-and-discharge ranges R1 to R3. Thus, the control system 60 may carry out an active control that includes controlling the amount of charge and discharge for each of the charge-and-discharge ranges R1 to R3, to cause substantially equal degradation of the battery modules 35 and 55.

### <Condition Determination Control, Part 1, Active Control>

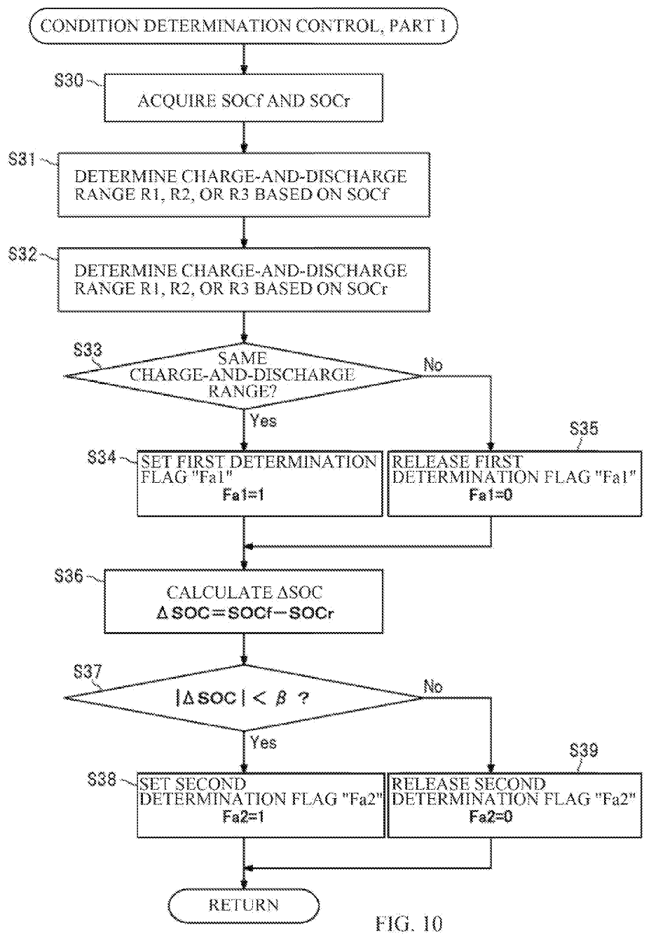

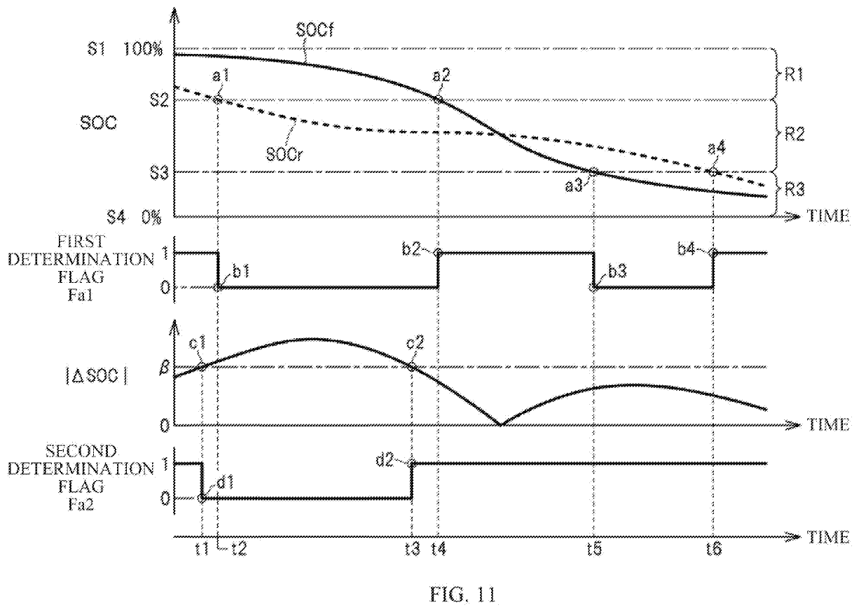

In the following, after describing a condition determination control, parts 1 and 2, the active control is described. The condition determination control, parts 1 and 2 includes determining a condition on which the active control is to be carried out. The active control is a degradation equalization control to cause the substantially equal degradation of the battery modules 35 and 55. FIG. 10 is a flowchart illustrating an example of a procedure of carrying out the condition determination control, part 1. FIG. 11 illustrates an example of an execution state of the condition determination control, part 1. Each step of the condition determination control, part 1 illustrated in FIG. 10 illustrates a process to be carried out by the processor 70 constituting the control system 60. The condition determination control, part 1 illustrated in FIG. 10 is a control to be carried out by the control system 60 at predetermined intervals after the start-up of the control system 60.

As illustrated in FIG. 10, in step S30, the SOCf and the SOCr of the battery modules 35 and 55 may be read. In step S31, based on the SOCf of the front battery module 35, the current charge-and-discharge range R1, R2, or R3 of the SOCf of the battery module 35 may be determined. In step S32, based on the SOCr of the rear battery module 55, the current charge-and-discharge range R1, R2, or R3 of the SOCr of the battery module 55 may be determined.

In step S33, it may be determined whether or not the charge-and-discharge range R1, R2, or R3 of the SOCf of the battery module 35 and the charge-and-discharge range R1, R2, or R3 of the SOCr of the battery module 55 are the same. In other words, it may be determined whether or not the SOCf of the battery module 35 and the SOCr of the battery module 55 are kept within the same charge-and-discharge range. In one embodiment of the disclosure, the same charge-and-discharge range may serve as a “same range”. In step S33, when it is determined that the SOCf of the battery module 35 and the SOCr of the battery module 55 are in the same charge-and-discharge range (Yes in step S33), the flow may proceed to step S34. In step S34, a first determination flag Fa1 may be set (Fa1=1). In step S33, when it is determined that the SOCf of the battery module 35 and the SOCr of the battery module 55 are not in the same charge-and-discharge range (No in step S33), the flow may proceed to step S35. In step S35, the first determination flag Fa1 may be released (Fa1=0).

In other words, as denoted by the time t2 in FIG. 11, when the SOCf is making transitions within the charge-and-discharge range R1 and the SOCr lowers to shift from the charge-and-discharge range R1 to the charge-and-discharge range R2 (reference characters a1), the first determination flag Fa1 may be released because the SOCf and the SOCr are in the different charge-and-discharge ranges R1 and R2 (reference characters b1). As denoted by the time t4, when the SOCr is making transitions within the charge-and-discharge range R2 and the SOCf lowers to shift from the charge-and-discharge range R1 to the charge-and-discharge range R2 (reference characters a2), the first determination flag Fa1 may be set (reference characters b2) because the SOCf and the SOCr are in the same charge-and-discharge range R2. As denoted by the time t5, when the SOCr is making transitions within the charge-and-discharge range R2 and the SOCf lowers to shift from the charge-and-discharge range R2 to the charge-and-discharge range R3 (reference characters a3), the first determination flag Fa1 may be released (reference characters b3) because the SOCf and the SOCr are in the different charge-and-discharge ranges R2 and R3. As denoted by the time t6, when the SOCf is making transitions within the charge-and-discharge range R3 and the SOCr lowers to shift from the charge-and-discharge range R2 to the charge-and-discharge range R3 (reference characters a4), the first determination flag Fa1 may be set (reference characters b4) because the SOCf and the SOCf are in the same charge-and-discharge range R3.

Moreover, as illustrated in the flowchart in FIG. 10, in step S36, the SOCr may be subtracted from the SOCf, to calculate ΔSOC, i.e., the difference in the SOC. Thereafter, in step S37, it may be determined whether or not the absolute value of ΔSOC is smaller than a predetermined starting threshold value β. In step S37, when it is determined that the absolute value of ΔSOC is smaller than the starting threshold value β (Yes in step S37), that is, when the SOCf and the SOCr are close to each other, the flow may proceed to step S38. In step S38, a second determination flag Fa2 may be set (Fa2=1). In step S37, when it is determined that the absolute value of ΔSOC is equal to or greater than the starting threshold value β (No in step S37), that is, when the SOCf and the SOCr are deviated from each other, the flow may proceed to step S39. In step S39, the second determination flag Fa2 may be released (Fa2=0).

That is, as denoted by the time t1 in FIG. 11, when the absolute value of ΔSOC becomes equal to or greater than the starting threshold value β (reference characters c1), the second determination flag Fa2 may be released (reference characters d1). As denoted by the time t3, when the absolute value of ΔSOC is smaller than the starting threshold value β (reference characters c2), the second determination flag Fa2 may be set (reference characters d2).

### <Condition Determination Control, Part 2, Active Control>

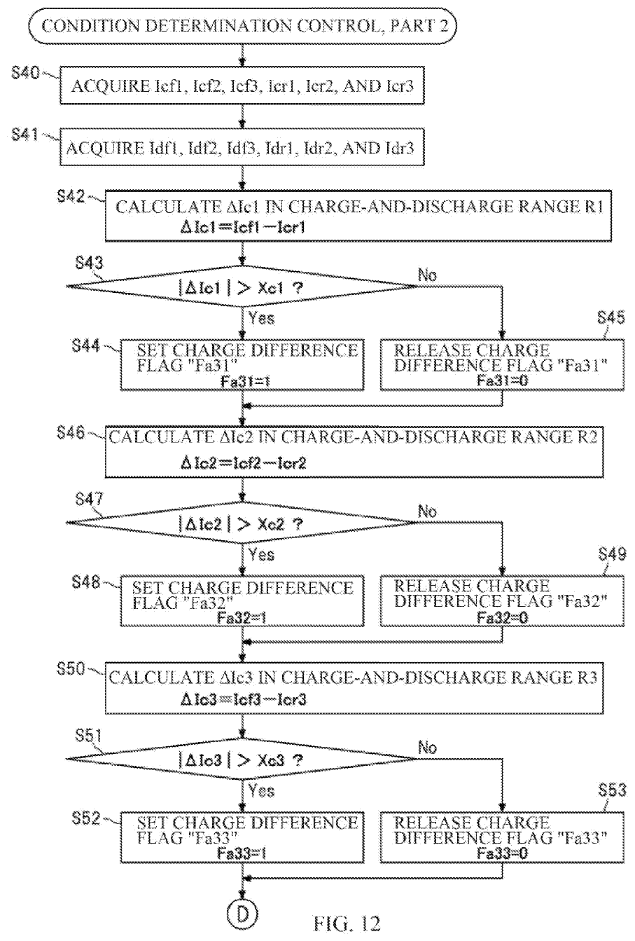

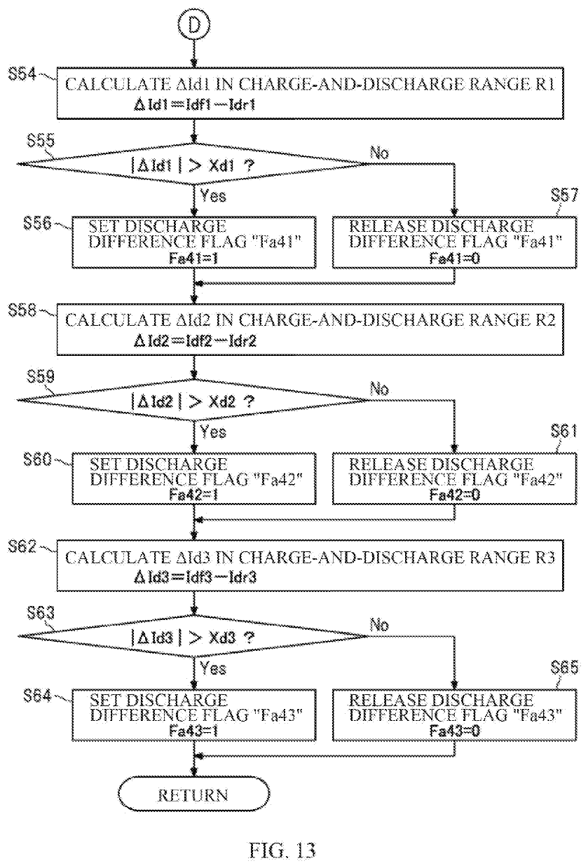

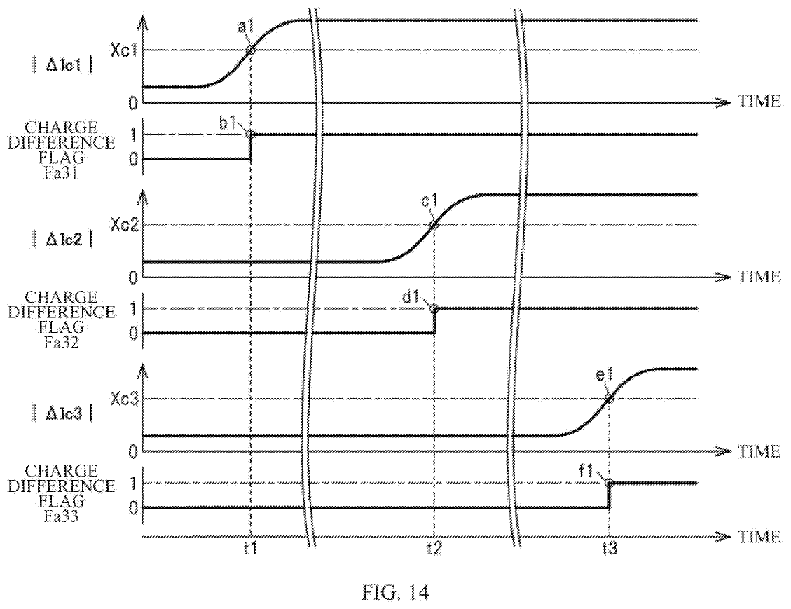

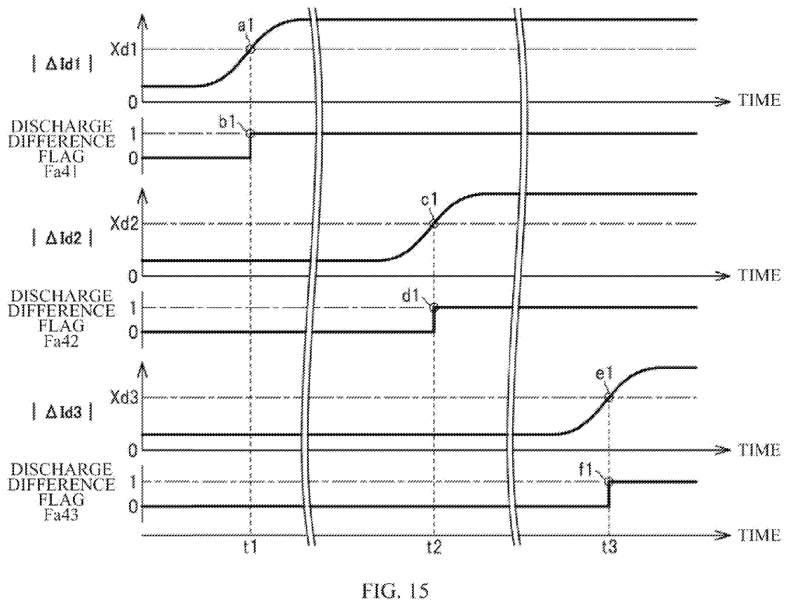

Description is given next of the condition determination control, part 2. The condition determination control, part 2 includes determining the condition on which the active control is to be carried out. FIGS. 12 and 13 are flowcharts illustrating an example of a procedure of carrying out the condition determination control, part 2. FIGS. 14 and 15 illustrate an example of an execution state of the condition determination control, part 2. The flowcharts illustrated in FIGS. 12 and 13 are coupled to each other at a position denoted by a reference character D. Each step of the condition determination control, part 2 illustrated in FIGS. 12 and 1-3 illustrates a process to be carried out by the processor 70 constituting the control system 60. The condition determination control, part 2 illustrated in FIGS. 12 and 13 is a control to be carried out by the control system 60 at predetermined intervals after the start-up of the control system 60.

As described, the front battery control unit 36 may calculate the accumulated amount of charge Icf and the accumulated amount of discharge Idf for each of the charge-and-discharge ranges R1 to R3. In the following description, the accumulated amount of charge Icf in the charge-and-discharge range R1 is referred to as “Icf1”. The accumulated amount of charge Icf in the charge-and-discharge range R2 is referred to as “Icf2”. The accumulated amount of charge Icf in the charge-and-discharge range R3 is referred to as “Icf3”. The accumulated amount of discharge Idf in the charge-and-discharge range R1 is referred to as “Idf1”. The accumulated amount of discharge Idf in the charge-and-discharge range R2 is referred to as “Idf2”. The accumulated amount of discharge Idf in the charge-and-discharge range R3 is referred to as “Idf3”.

Moreover, as described, the rear battery control unit 56 may calculate the accumulated amount of charge Icr and the accumulated amount of discharge Idr for each of the charge-and-discharge ranges R1 to R3. In the following description, the accumulated amount of charge Icr in the charge-and-discharge range R1 is referred to as “Icr1”. The accumulated amount of charge Icr in the charge-and-discharge range R2 is referred to as “Icr2”. The accumulated amount of charge Icr in the charge-and-discharge range R3 is referred to as “Icr3”. The accumulated amount of discharge Idr in the charge-and-discharge range R1 is referred to as “Idr1”. The accumulated amount of discharge Idr in the charge-and-discharge range R2 is referred to as “Idr2”. The accumulated amount of discharge Idr in the charge-and-discharge range R3 is referred to as “Idr3”.

As illustrated in FIG. 12, in step S40, the accumulated amounts of charge Icf1, Icf2, and Icf3 of the battery module 35 may be read, and the accumulated amounts of charge Icr1, Icr2, and Icr3 of the battery module 55 may be read. Thereafter, in step S41, the accumulated amounts of discharge Idf1, Idf2, and Idf3 of the battery module 35 may be read, and the accumulated amounts of discharge Idr1, Idr2, and Idr3 of the battery module 55 may be read.

In step S42, the accumulated amount of charge Icr1 may be subtracted from the accumulated amount of charge Icf1, to calculate a difference ΔIc1 in the accumulated amount of charge in the charge-and-discharge range R1. Thereafter, in step S43, it may be determined whether or not an absolute value of the difference ΔIc1 is greater than a predetermined amount-of-charge threshold value Xc1. In step S43, when it is determined that the absolute value of the difference ΔIc1 is greater than the amount-of-charge threshold value Xc1 (Yes in step S43), the accumulated amounts of charge in the charge-and-discharge range R1 are deviated, and the flow may proceed to step S44. In step S44, a charge difference flag Fa31 may be set (Fa31=1). In step S43, when it is determined that the absolute value of the difference ΔIc1 is equal to or smaller than the amount-of-charge threshold value Xc1 (No in step S43), the accumulated amounts of charge in the charge-and-discharge range R1 are not deviated, and the flow may proceed to step S45. In step S45, the charge difference flag Fa31 may be released (Fa31=0).

In step S46, the accumulated amount of charge Icr2 may be subtracted from the accumulated amount of charge Icf2, to calculate a difference ΔIc2 in the accumulated amount of charge in the charge-and-discharge range R2. Thereafter, in step S47, it may be determined whether or not an absolute value of the difference ΔIc2 is greater than a predetermined amount-of-charge threshold value Xc2. In step S47, when it is determined that the absolute value of the difference ΔIc2 is greater than the amount-of-charge threshold value Xc2 (Yes in step S47), the accumulated amounts of charge in the charge-and-discharge range R2 are deviated, and the flow may proceed to step S48. In step S48, a charge difference flag Fa32 may be set (Fa32=1). In step S47, when it is determined that the absolute value of the difference ΔIc2 is equal to or smaller than the amount-of-charge threshold value Xc2 (No in step S47), the accumulated amounts of charge in the charge-and-discharge range R2 are not deviated, and the flow may proceed to step S49. In step S49, the charge difference flag Fa32 may be released (Fa32=0).

In step S50, the accumulated amount of charge Icr3 may be subtracted from the accumulated amount of charge Icf3, to calculate a difference ΔIc3 in the accumulated amount of charge in the charge-and-discharge range R3. Thereafter, in step S51, it may be determined whether or not an absolute value of the difference ΔIc3 is greater than a predetermined amount-of-charge threshold value Xc3. In step S51, when it is determined that the absolute value of the difference ΔIc3 is greater than the amount-of-charge threshold value Xc3 (Yes in step S51), the accumulated amounts of charge in the charge-and-discharge range R3 are deviated, and the flow may proceed to step S52. In step S52, a charge difference flag Fa33 may be set (Fa33=1). In step S51, when it is determined that the absolute value of the difference ΔIc3 is equal to or smaller than the amount-of-charge threshold value Xc3 (No in step S51), the accumulated amounts of charge in the charge-and-discharge range R3 are not deviated, and the flow may proceed to step S53. In step S53, the charge difference flag Fa33 may be released (Fa33=0).

That is, as denoted by the time t1 in FIG. 14, when the absolute value of the difference ΔIc1 in the accumulated amount of charge in the charge-and-discharge range R1 is greater than the predetermined amount-of-charge threshold value Xc1 (reference characters a1), the charge difference flag Fa31 may be set (reference characters b1). As denoted by the time t2, when the absolute value of the difference ΔIc2 in the accumulated amount of charge in the charge-and-discharge range R2 is greater than the predetermined amount-of-charge threshold value Xc2 (reference characters c1), the charge difference flag Fa32 may be set (reference characters d1). As denoted by the time t3, when the absolute value of the difference ΔIc3 in the accumulated amount of charge in the charge-and-discharge range R3 is greater than the predetermined amount-of-charge threshold value Xc3 (reference characters e1), the charge difference flag Fa33 may be set (reference characters f1).

Moreover, as illustrated in the flowchart in FIG. 13, in step S54, the accumulated amount of discharge Idr1 may be subtracted from the accumulated amount of discharge Idf1, to calculate a difference ΔId1 in the accumulated amount of discharge in the charge-and-discharge range R1. Thereafter, in step S55, it may be determined whether or not an absolute value of the difference ΔId1 is greater than a predetermined amount-of-discharge threshold value Xd1. In step S55, when it is determined that the absolute value of the difference ΔId1 is greater than the amount-of-discharge threshold value Xd1 (Yes in step S55), the accumulated amounts of discharge in the charge-and-discharge range R1 are deviated, and the flow may proceed to step S56. In step S56, a discharge difference flag Fa41 may be set (Fa41=1). In step S55, when it is determined that the absolute value of the difference ΔId1 is equal to or smaller than the amount-of-discharge threshold value Xd1 (No in step S55), the accumulated amounts of discharge in the charge-and-discharge range R1 are not deviated, and the flow may proceed to step S57. In step S57, the discharge difference flag Fa41 may be released (Fa41=0).

Thereafter, in step S58, the accumulated amount of discharge Idr2 may be subtracted from the accumulated amount of discharge Idf2, to calculate a difference ΔId2 in the accumulated amount of discharge in the charge-and-discharge range R2. Thereafter, in step S59, it may be determined whether or not the absolute value of the difference ΔId2 is greater than a predetermined amount-of-discharge threshold value Xd2. In step S59, when it is determined that the absolute value of the difference ΔId2 is greater than the amount-of-discharge threshold value Xd2 (Yes in step S59), the accumulated amounts of discharge in the charge-and-discharge range R2 are deviated, and the flow may proceed to step S60. In step S60, a discharge difference flag Fa42 may be set (Fa42=1). In step S59, when it is determined that the absolute value of the difference ΔId2 is equal to or smaller than the amount-of-discharge threshold value Xd2 (No in step S59), the accumulated amounts of discharge in the charge-and-discharge range R2 are not deviated, and the flow may proceed to step S61. In step S61, the discharge difference flag Fa42 may be released (Fa42=0).

Thereafter, in step S62, the accumulated amount of discharge Idr3 may be subtracted from the accumulated amount of discharge Idf3, to calculate a difference ΔId3 in the accumulated amount of discharge in the charge-and-discharge range R3. Thereafter, in step S63, it may be determined whether or not an absolute value of the difference ΔId3 is greater than a predetermined amount-of-discharge threshold value Xd3. In step S63, when it is determined that the absolute value of the difference ΔId3 is greater than the amount-of-discharge threshold value Xd3 (Yes in step S63), the accumulated amounts of discharge in the charge-and-discharge range R3 are deviated, and the flow may proceed to step S64. In step S64, a discharge difference flag Fa43 may be set (Fa43=1). In step S63, when it is determined that the absolute value of the difference ΔId3 is equal to or smaller than the amount-of-discharge threshold value Xd3 (No in step S63), the accumulated amounts of discharge in the charge-and-discharge range R3 are not deviated, and the flow may proceed to step S65. In step S65, the discharge difference flag Fa43 may be released (Fa43=0).

That is, as denoted by the time t1 in FIG. 15, when the absolute value of the difference ΔId1 in the accumulated amount of discharge in the charge-and-discharge range R1 is greater than the predetermined amount-of-discharge threshold value Xd1 (reference characters a1), the discharge difference flag Fa41 may be set (reference characters b1). As denoted by the time t2, when the absolute value of the difference ΔId2 in the accumulated amount of discharge in the charge-and-discharge range R2 is greater than the predetermined amount-of-discharge threshold value Xd2 (reference characters c1), the discharge difference flag Fa42 may be set (reference characters d1). As denoted by the time t3, when the absolute value of the difference ΔId3 in the accumulated amount of discharge in the charge-and-discharge range R3 is greater than the predetermined amount-of-discharge threshold value Xd3 (reference characters e1), the discharge difference flag Fa43 may be set (reference characters f1).

### <Active Control>

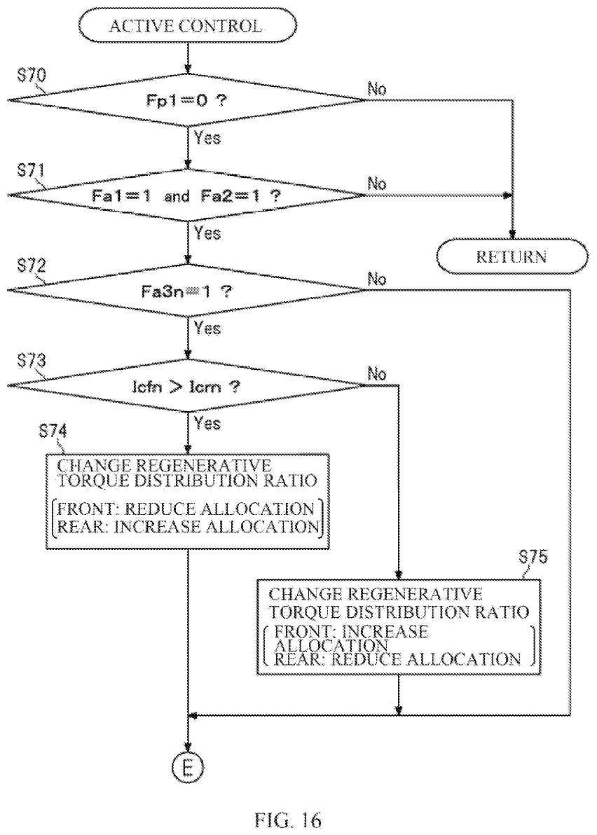

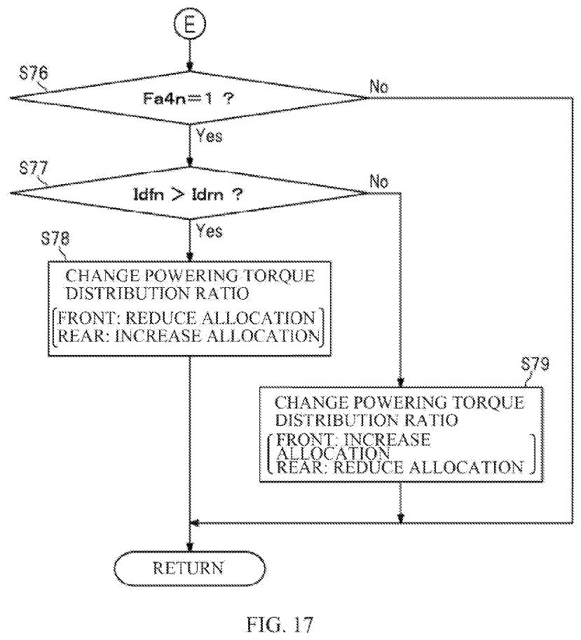

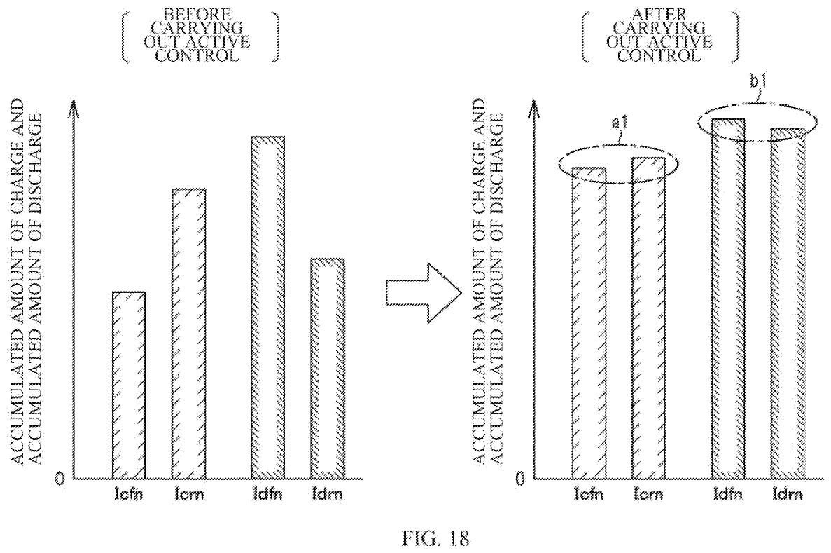

Description is given next of the active control. The active control includes the degradation equalization control to cause the substantially equal degradation of the battery modules 35 and 55. FIGS. 16 and 17 are flowcharts illustrating an example of a procedure of carrying out the active control. FIG. 18 illustrates an example of changes in the accumulated amount of charge and the accumulated amount of discharge before and after carrying out the active control. The flowcharts illustrated in FIGS. 16 and 17 are coupled to each other at a position denoted by a reference character E. Each step of the active control illustrated in FIGS. 16 and 17 illustrates a process to be carried out by the processor 70 constituting the control system 60. The active control illustrated in FIGS. 16 and 17 is a control to be carried out by the control system 60 at predetermined intervals after the start-up of the control system 60.

In the following description, any one of the accumulated amounts of charge Icf1, Icf2, and Icf3 is referred to as “Icfn”. Any one of the accumulated amounts of discharge Idf1, Idf2, and Idf3 is referred to as “Idfn”. Any one of the accumulated amounts of charge Icr1, Icr2, and Icr3 is referred to as “Icrn”. Any one of the accumulated amounts of discharge Idr1, Idr2, Idr3 is referred to as “Idrn”. Any of the charge difference flags Fa31, Fa32, and Fa33 is referred to as “Fa3n”. Any of the discharge difference flags Fa41, Fa42, Fa43 is referred to as “Fa4n”.

As illustrated in FIG. 16, in step S70, it may be determined whether or not the passive control flag Fp1 mentioned above has been released. In step S70, when it is determined that the passive control flag Fp1 has been set (No in step S70), that is, when it is determined that the passive control to eliminate ΔSOC is being carried out, the routine may be ended without carrying out the active control.

In step S71, it may be determined whether or not both the first determination flag Fa1 and the second determination flag Fa2 have been set. Here, as illustrated in FIG. 11, a state in which the first determination flag Fa1 has been set is a state in which the SOCf and the SOCr are kept within the same one of the charge-and-discharge range R1 to R3. A state in which the second determination flag Fa2 has been set is a state in which the difference ΔSOC between the SOCf and the SOCr is smaller than the threshold value f3. In step S71, when either the first determination flag Fa1 or the second determination flag Fa2 has been released (No in step S71), that is, when the SOCf and the SOCr are kept within different ones of the charge-and-discharge ranges R1 to R3, or when the difference ΔSOC between the SOCf and the SOCr is greater than the threshold value (3, the situation is that the active control is not to be carried out, and the routine may be ended without carrying out the active control.

In step S71, when it is determined that both the first determination flag Fa1 and the second determination flag Fa2 have been set (Yes in step S71), the flow may proceed to step S72. In step S72, it may be determined whether or not the charge difference flag Fa3n has been set with respect to the same one of the charge-and-discharge ranges R1 to R3 within which the SOCf and the SOCr are kept. For example, when both the SOCf and the SOCr are kept within the charge-and-discharge range R1, it may be determined whether or not the charge difference flag Fa31 in the charge-and-discharge range R1, i.e., the same range, has been set. In step S72, when it is determined that the charge difference flag Fa3n has been set (Yes in step S72), that is, when the first accumulated amount of charge Icfn and the second accumulated amount of charge Icrn are deviated, the flow may proceed to step S73. In step S73, the active control may be started. The active control includes eliminating a difference between the accumulated amount of charge Icfn and the accumulated amount of charge Icrn.

In step S73, it may be determined whether or not the accumulated amount of charge Icfn is greater than the accumulated amount of charge Icrn. In step S73, when it is determined that the accumulated amount of charge Icfn is greater than the accumulated amount of charge Icrn (Yes in step S73), the accumulated amount of charge Icfn of the front battery module 35 is great, and the flow may proceed to step S74. In step S74, the regenerative torque distribution ratio between the front motor 31 and the rear motor 51 may be changed from the predetermined reference distribution ratio. That is, the regenerative torque to be allocated to the front motor 31 may be changed to be reduced to a smaller value than the regenerative torque to be allocated based on the reference distribution ratio, to suppress the charging of the front battery module 35. The regenerative torque to be allocated to the rear motor 51 may be changed to be increased to a greater value than the regenerative torque to be allocated based on the reference distribution ratio, to promote the charging of the rear battery module 55. This makes it possible, as denoted by reference characters a1 in FIG. 18, to bring the accumulated amount of charge Icfn and the accumulated amount of charge Icrn closer to each other. Hence, it is possible to cause similar degradation of the battery modules 35 and 55.

In step S73, when it is determined that the accumulated amount of charge Icfn is smaller than the accumulated amount of charge Icrn (No in step S73), the accumulated amount of charge Icfn of the front battery module 35 is small, and the flow may proceed to step S75. In step S75, the regenerative torque distribution ratio between the front motor 31 and the rear motor 51 may be changed from the predetermined reference distribution ratio. That is, the regenerative torque to be allocated to the front motor 31 may be changed to be increased to a greater value than the regenerative torque to be allocated based on the reference distribution ratio, to promote the charging of the front battery module 35. The regenerative torque to be allocated to the rear motor 51 may be changed to be reduced to a smaller value than the regenerative torque to be allocated based on the reference distribution ratio, to suppress the charging of the rear battery module 55. This makes it possible, as denoted by reference characters a1 in FIG. 18, to bring the accumulated amount of charge Icfn and the accumulated amount of charge km closer to each other. Hence, it is possible to cause the similar degradation of the battery modules 35 and 55.

Thereafter, the flow may proceed to step S76. In step S76, it may be determined whether or not the discharge difference flag Fa4n has been set with respect to the same charge-and-discharge range within which the SOCf and the SOCr are kept. For example, when both the SOCf and the SOCr are kept within the charge-and-discharge range R1, it may be determined whether or not the discharge difference flag Fa41 in the charge-and-discharge range R1, i.e., the same range, has been set. In step S76, when it is determined that the discharge difference flag Fa4n has been set (Yes in step S76), that is, when the first accumulated amount of discharge Idfn and the second accumulated amount of discharge Idrn are deviated, the flow may proceed to step S77. In step S77, the active control may be started. The active control includes eliminating a difference between the accumulated amount of discharge Idfn and the accumulated amount of discharge Idrn.

In step S77, it may be determined whether or not the accumulated amount of discharge Idfn is greater than the accumulated amount of discharge Idrn. In step S77, when it is determined that the accumulated amount of discharge Idfn is greater than the accumulated amount of discharge Idrn (Yes in step S77), the accumulated amount of discharge Idfn of the front battery module 35 is great, and the flow may proceed to step S78. In step S78, the powering torque distribution ratio between the front motor 31 and the rear motor 51 may be changed from the predetermined reference distribution ratio. That is, the powering torque to be allocated to the front motor 31 may be changed to be reduced to a smaller value than the powering torque to be allocated based on the reference distribution ratio, to suppress the discharging of the front battery module 35. The powering torque to be allocated to the rear motor 51 may be changed to be increased to a greater value than the powering torque to be allocated based on the reference distribution ratio, to promote the discharging of the rear battery module 55. This makes it possible, as denoted by reference characters b1 in FIG. 18, to bring the accumulated amount of discharge Idfn and the accumulated amount of discharge Idrn closer to each other. Hence, it is possible to cause the similar degradation of the battery modules 35 and 55.

In step S77, when it is determined that the accumulated amount of discharge Idfn is smaller than the accumulated amount of discharge Idrn (No in step S77), the accumulated amount of discharge Idfn of the front battery module 35 is small, and the flow may proceed to step S79. In step S79, the powering torque distribution ratio between the front motor 31 and the rear motor 51 may be changed from the predetermined reference distribution ratio. That is, the powering torque to be allocated to the front motor 31 may be changed to be increased to a greater value than the powering torque to be allocated based on the reference distribution ratio, to promote the discharging of the front battery module 35. The powering torque to be allocated to the rear motor 51 may be changed to be reduced to a smaller value than the powering torque to be allocated based on the reference distribution ratio, to suppress the discharging of the rear battery module 55. This makes it possible, as denoted by reference characters b1 in FIG. 18, to bring the accumulated amount of discharge Idfn and the accumulated amount of discharge Idrn closer to each other. Hence, it is possible to cause the similar degradation of the battery modules 35 and 55.

As described, carrying out the active control makes it possible to bring the accumulated amount of charge Icfn of the front battery module 35 and the accumulated amount of charge Icrn of the rear battery module 55 closer to each other for each of the charge-and-discharge ranges R1 to R3. Hence, it is possible to cause the similar degradation of the battery modules 35 and 55. Moreover, carrying out the active control makes it possible to bring the accumulated amount of discharge Idfn of the front battery module 35 and the accumulated amount of discharge Idrn of the rear battery module 55 closer to each other for each of the charge-and-discharge ranges R1 to R3.

Hence, it is possible to cause the similar degradation of the battery modules 35 and 55.

### <Temperature Correction of Accumulated Amount of Charge and Accumulated Amount of Discharge>

As described, the front battery control unit 36 may calculate the accumulated amount of charge Icfn by accumulating the charge current of the battery module 35, and calculate the accumulated amount of discharge Idfn by accumulating the discharge current of the battery module 35. The rear battery control unit 56 may calculate the accumulated amount of charge km by accumulating the charge current of the battery module 55, and calculate the accumulated amount of discharge Idrn by accumulating the discharge current of the battery module 55.

Degradation states of the battery modules 35 and 55 depend not only on the amount of charge and discharge but also on the temperatures of the battery modules 35 and 55. That is, when the charging and discharging of the battery modules 35 and 55 is carried out in a high-temperature environment, it is assumed that the degradation of the battery modules 35 and 55 progresses more than when the charging and discharging of the battery modules 35 and 55 is carried out in a normal temperature environment at a lower temperature than the high-temperature environment. To accurately reflect such degradation states of the battery modules 35 and 55, the accumulated amounts of charge Icfn and Icrn, and the accumulated amounts of discharge Idfn and Idrn may be corrected based on the temperatures of the battery modules 35 and 55.

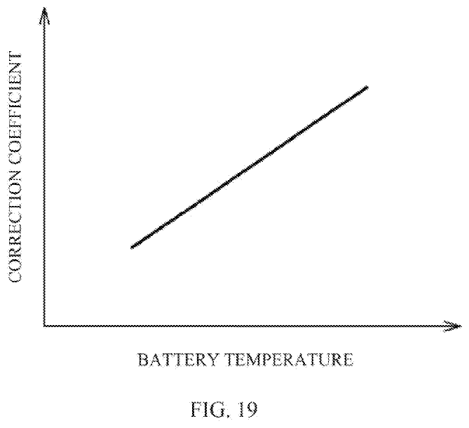

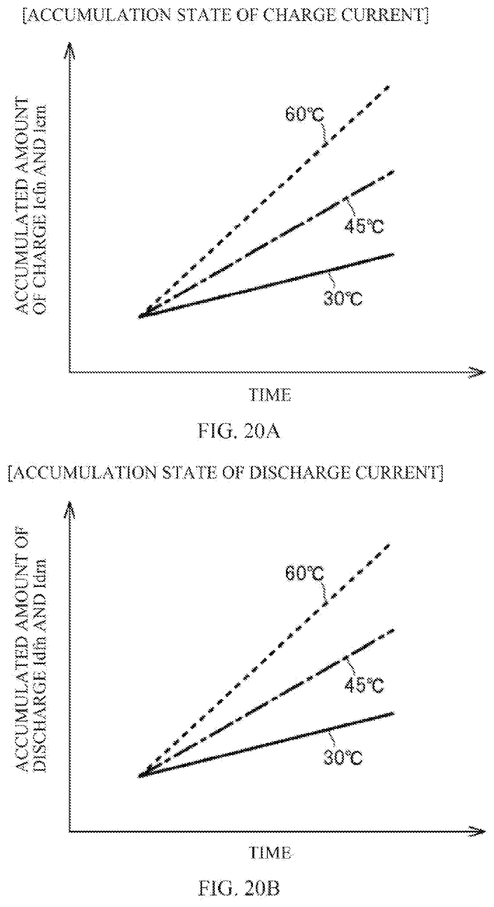

FIG. 19 illustrates an example of a correction coefficient provided for correction of the charge current and the discharge current. FIG. 20A illustrates an example of an accumulation state of the charge current. FIG. 20B illustrates an example of an accumulation state of the discharge current. As illustrated in FIG. 19, the correction coefficient may be set to become greater as the temperatures of the battery modules 35 and 55 become higher. Hereinafter, the temperatures of the battery modules 35 and 55 are referred to as battery temperatures. When calculating the accumulated amounts of charge Icfn and Icrn, the charge current multiplied by the correction coefficient may be accumulated. When calculating the accumulated amounts of discharge Idfn and Idrn, the discharge current multiplied by the correction coefficient may be accumulated.

That is, as illustrated in FIG. 20A, even when the same charge current flows through the battery modules 35 and 55, the accumulated amounts of charge Icfn and km become greater as the battery temperatures become higher. For example, even in a case where the same charge current flows, when the battery temperatures are 45° C., the accumulated amounts of charge Icfn and Icrn become greater than those when the battery temperatures are 30° C. For example, even in the case where the same charge current flows, when the battery temperatures are 60° C., the accumulated amounts of charge Icfn and Icrn become greater than those when the battery temperatures are 45° C. Moreover, as illustrated in FIG. 20B, even when the same discharge current flows from the battery modules 35 and 55, the accumulated amounts of discharge Idfn and Idrn become greater as the battery temperatures become higher. For example, even in a case where the same discharge current flows, when the battery temperatures are 45° C., the accumulated amounts of discharge Idfn and Idrn become greater than those when the battery temperatures are 30° C. For example, even in the case where the same discharge current flows, when the battery temperature is 60° C., the accumulated amounts of discharge Idfn and Idrn become greater than those when the battery temperatures are 45° C. This makes it possible to appropriately reflect influences of the battery temperatures on the degradation states, and to appropriately adjust the degradation states of the battery modules 35 and 55 by the active control.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, in the foregoing description, the control system 60 includes five control units, but this is non-limiting. The control system 60 may include one control unit, or alternatively, the control system 60 may include two to four control units. In another alternative, and the control system 60 may include six or more control units. The accumulated amounts of charge Icfn and Icrn may be an accumulated amount of charge inclusive of a charge current on the occasion of external charging using an external power supply. Alternatively, the accumulated amounts of charge Icfn and Icrn may be an accumulated amount of charge excluding the charge current on the occasion of the external charging.

In the forgoing description, both the passive control and the active control are carried out, but this is non-limiting. Solely the passive control may be carried out, or alternatively, solely the active control may be carried out. In the forgoing description, the active control is carried out for all the charge-and-discharge ranges R1 to R3, but this is non-limiting. The active control may be carried out for any one of the charge-and-discharge ranges R1 to R3. The amount-of-charge threshold values Xc1, Xc2, and Xc3 may have the same value or may have different values from one another. The amount-of-discharge threshold values Xd1, Xd2, and Xd3 may have the same value or may have different values from one another. In the forgoing description, the three charge-and-discharge ranges R1 to R3 are set for the battery modules 35 and 55, but this is non-limiting. Two charge-and-discharge ranges may be set for the battery modules 35 and 55, or alternatively, four or more charge-and-discharge ranges may be set for the battery modules 35 and 55.

In the forgoing description, the battery modules 35 and 55 include lithium-ion batteries, but this is non-limiting. Any accumulators may be adopted as long as the accumulators have different degradation characteristics depending on their capacities. The battery modules 35 and 55 in the figure include lithium-ion batteries of the same kind, but this is non-limiting. Any accumulators may be adopted as long as the accumulators have similar degradation characteristics to each other. The upper limit capacities the battery modules 35 and 55, or the boundary value S1 as the “upper limit state of charge”, may be the same as each other, or may be slightly deviated. The lower limit capacities of the battery modules 35 and 55, or the boundary value S4 as the “lower limit state of charge”, may be the same as each other, or may be slightly deviated.

In the example in the figure, the single front motor 31 is coupled to the left and right front wheels 20, but this is non-limiting. One front motor may be coupled to the single front wheel 20. Similarly, the single rear motor 51 is coupled to the left and right rear wheels 40, but this is non-limiting. One rear motor may be coupled to the single rear wheel 40. The vehicle 11 in the figure is an electric vehicle devoid of an engine, but this is non-limiting. The vehicle control apparatus of the embodiments of the disclosure may be applied to, for example, a series hybrid vehicle.

According to the embodiments of the disclosure, when a difference between a state of charge of a first accumulator and a state of charge of a second accumulator is greater than a threshold value, one or more processors of a control system are configured to change a torque distribution ratio between a first travel motor and a second travel motor from a reference distribution ratio. Hence, it is possible to continue motor driving of front wheels and rear wheels.

The front battery control unit 36, the front motor control unit 38, the rear battery control unit 56, the rear motor control unit 58, and the vehicle control unit 61 constituting the control system 60 illustrated in FIGS. 1 to 3 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control units 36, 38, 56, 58, and 61. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control units 36, 38, 56, 58, and 61 illustrated in FIGS. 1 to 3.

1. A vehicle control apparatus to be applied to a vehicle, the vehicle control apparatus comprising:
a front-wheel driving system including a first travel motor and a first accumulator, the first travel motor being mechanically coupled to a front wheel of the vehicle, and the first accumulator being electrically coupled to the first travel motor;
a rear-wheel driving system including a second travel motor and a second accumulator, the second travel motor being mechanically coupled to a rear wheel of the vehicle, and the second accumulator being electrically coupled to the second travel motor; and
a control system including one or more processors and one or more memories communicably coupled to the one or more processors, the control system being configured to control the first travel motor and the second travel motor, wherein
the one or more processors are configured to when a difference between a state of charge of the first accumulator and a state of charge of the second accumulator is greater than a threshold value, change a torque distribution ratio between the first travel motor and the second travel motor from a reference distribution ratio.

2. The vehicle control apparatus according to claim 1, wherein the one or more processors are configured to,
when the difference between the state of charge of the first accumulator and the state of charge of the second accumulator is greater than the threshold value, and the state of charge of the first accumulator is greater than the state of charge of the second accumulator,
change a powering torque distribution ratio between the first travel motor and the second travel motor from the reference distribution ratio,
thereby increasing powering torque to be allocated to the first travel motor to a greater value than powering torque to be allocated based on the reference distribution ratio, and reducing powering torque to be allocated to the second travel motor to a smaller value than powering torque to be allocated based on the reference distribution ratio, and
when the difference between the state of charge of the first accumulator and the state of charge of the second accumulator is greater than the threshold value, and the state of charge of the first accumulator is smaller than the state of charge of the second accumulator,
change the powering torque distribution ratio between the first travel motor and the second travel motor from the reference distribution ratio,
thereby reducing the powering torque to be allocated to the first travel motor to a smaller value than the powering torque to be allocated based on the reference distribution ratio, and increasing the powering torque to be allocated to the second travel motor to a greater value than the powering torque to be allocated based on the reference distribution ratio.

3. The vehicle control apparatus according to claim 1, wherein the one or more processors are configured to
when the difference between the state of charge of the first accumulator and the state of charge of the second accumulator is greater than the threshold value, and the state of charge of the first accumulator is greater than the state of charge of the second accumulator,
change a regenerative torque distribution ratio between the first travel motor and the second travel motor from the reference distribution ratio,
thereby reducing regenerative torque to be allocated to the first travel motor to a smaller value than regenerative torque to be allocated based on the reference distribution ratio, and increasing regenerative torque to be allocated to the second travel motor to a greater value than regenerative torque to be allocated based on the reference distribution ratio, and
when the difference between the state of charge of the first accumulator and the state of charge of the second accumulator is greater than the threshold value, and the state of charge of the first accumulator is smaller than the state of charge of the second accumulator,
change the regenerative torque distribution ratio between the first travel motor and the second travel motor from the reference distribution ratio,
thereby increasing the regenerative torque to be allocated to the first travel motor to a greater value than the regenerative torque to be allocated based on the reference distribution ratio, and reducing the regenerative torque to be allocated to the second travel motor to a smaller value than the regenerative torque to be allocated based on the reference distribution ratio.

4. The vehicle control apparatus according to claim 1, wherein
a segment between a lower limit state of charge and an upper limit state of charge in the first accumulator and the second accumulator is separated into charge-and-discharge ranges,
the one or more processors are configured to
accumulate a charge current of the first accumulator for each of the charge-and-discharge ranges, to calculate a first accumulated amount of charge, and
accumulate a charge current of the second accumulator for each of the charge-and-discharge ranges, to calculate a second accumulated amount of charge,
in a state in which the state of charge of the first accumulator and the state of charge of the second accumulator are kept within a same range that is any one of the charge-and-discharge ranges, the one or more processors are configured to,
when that a difference between the first accumulated amount of charge and the second accumulated amount of charge in the same range is greater than an amount-of-charge threshold value, and the first accumulated amount of charge is greater than the second accumulated amount of charge in the same range,
change a regenerative torque distribution ratio between the first travel motor and the second travel motor from the reference distribution ratio,
thereby reducing regenerative torque to be allocated to the first travel motor to a smaller value than regenerative torque to be allocated based on the reference distribution ratio, and increasing regenerative torque to be allocated to the second travel motor to a greater value than regenerative torque to be allocated based on the reference distribution ratio, and
in the state in which the state of charge of the first accumulator and the state of charge of the second accumulator are kept within the same range that is any one of the charge-and-discharge ranges, the one or more processors are configured to,
when that the difference between the first accumulated amount of charge and the second accumulated amount of charge in the same range is greater than the amount-of-charge threshold value, and the first accumulated amount of charge is smaller than the second accumulated amount of charge in the same range,
change the regenerative torque distribution ratio between the first travel motor and the second travel motor from the reference distribution ratio,
thereby increasing the regenerative torque to be allocated to the first travel motor to a greater value than the regenerative torque to be allocated based on the reference distribution ratio, and reducing the regenerative torque to be allocated to the second travel motor to a smaller value than the regenerative torque to be allocated based on the reference distribution ratio.

5. The vehicle control apparatus according to claim 2, wherein
a segment between a lower limit state of charge and an upper limit state of charge in the first accumulator and the second accumulator is separated into charge-and-discharge ranges,
the one or more processors are configured to
accumulate a charge current of the first accumulator for each of the charge-and-discharge ranges, to calculate a first accumulated amount of charge, and
accumulate a charge current of the second accumulator for each of the charge-and-discharge ranges, to calculate a second accumulated amount of charge,
in a state in which the state of charge of the first accumulator and the state of charge of the second accumulator are kept within a same range that is any one of the charge-and-discharge ranges, the one or more processors are configured to,
when that a difference between the first accumulated amount of charge and the second accumulated amount of charge in the same range is greater than an amount-of-charge threshold value, and the first accumulated amount of charge is greater than the second accumulated amount of charge in the same range,
change a regenerative torque distribution ratio between the first travel motor and the second travel motor from the reference distribution ratio,
thereby reducing regenerative torque to be allocated to the first travel motor to a smaller value than regenerative torque to be allocated based on the reference distribution ratio, and increasing regenerative torque to be allocated to the second travel motor to a greater value than regenerative torque to be allocated based on the reference distribution ratio, and
in the state in which the state of charge of the first accumulator and the state of charge of the second accumulator are kept within the same range that is any one of the charge-and-discharge ranges, the one or more processors are configured to,
when that the difference between the first accumulated amount of charge and the second accumulated amount of charge in the same range is greater than the amount-of-charge threshold value, and the first accumulated amount of charge is smaller than the second accumulated amount of charge in the same range,
change the regenerative torque distribution ratio between the first travel motor and the second travel motor from the reference distribution ratio,
thereby increasing the regenerative torque to be allocated to the first travel motor to a greater value than the regenerative torque to be allocated based on the reference distribution ratio, and reducing the regenerative torque to be allocated to the second travel motor to a smaller value than the regenerative torque to be allocated based on the reference distribution ratio.

6. The vehicle control apparatus according to claim 3, wherein
a segment between a lower limit state of charge and an upper limit state of charge in the first accumulator and the second accumulator is separated into charge-and-discharge ranges,
the one or more processors are configured to
accumulate a charge current of the first accumulator for each of the charge-and-discharge ranges, to calculate a first accumulated amount of charge, and
accumulate a charge current of the second accumulator for each of the charge-and-discharge ranges, to calculate a second accumulated amount of charge,
in a state in which the state of charge of the first accumulator and the state of charge of the second accumulator are kept within a same range that is any one of the charge-and-discharge ranges, the one or more processors are configured to,
when that a difference between the first accumulated amount of charge and the second accumulated amount of charge in the same range is greater than an amount-of-charge threshold value, and the first accumulated amount of charge is greater than the second accumulated amount of charge in the same range,
change the regenerative torque distribution ratio between the first travel motor and the second travel motor from the reference distribution ratio,
thereby reducing the regenerative torque to be allocated to the first travel motor to a smaller value than the regenerative torque to be allocated based on the reference distribution ratio, and increasing the regenerative torque to be allocated to the second travel motor to a greater value than the regenerative torque to be allocated based on the reference distribution ratio, and
in the state in which the state of charge of the first accumulator and the state of charge of the second accumulator are kept within the same range that is any one of the charge-and-discharge ranges, the one or more processors are configured to,
when that the difference between the first accumulated amount of charge and the second accumulated amount of charge in the same range is greater than the amount-of-charge threshold value, and the first accumulated amount of charge is smaller than the second accumulated amount of charge in the same range,
change the regenerative torque distribution ratio between the first travel motor and the second travel motor from the reference distribution ratio,
thereby increasing the regenerative torque to be allocated to the first travel motor to a greater value than the regenerative torque to be allocated based on the reference distribution ratio, and reducing the regenerative torque to be allocated to the second travel motor to a smaller value than the regenerative torque to be allocated based on the reference distribution ratio.

7. The vehicle control apparatus according to claim 1, wherein
a segment between a lower limit state of charge and an upper limit state of charge in the first accumulator and the second accumulator is separated into charge-and-discharge ranges,
the one or more processors are configured to
accumulate a discharge current of the first accumulator for each of the charge-and-discharge ranges, to calculate a first accumulated amount of discharge, and
accumulate a discharge current of the second accumulator for each of the charge-and-discharge ranges, to calculate a second accumulated amount of discharge,
in a state in which the state of charge of the first accumulator and the state of charge of the second accumulator are kept within a same range that is any one of the charge-and-discharge ranges, the one or more processors are configured to,
when a difference between the first accumulated amount of discharge and the second accumulated amount of discharge in the same range is greater than an amount-of-discharge threshold value, and the first accumulated amount of discharge is greater than the second accumulated amount of discharge in the same range,
change a powering torque distribution ratio between the first travel motor and the second travel motor from the reference distribution ratio,
thereby reducing powering torque to be allocated to the first travel motor to a smaller value than powering torque to be allocated based on the reference distribution ratio, and increasing powering torque to be allocated to the second travel motor to a greater value than powering torque to be allocated based on the reference distribution ratio, and
in the state in which the state of charge of the first accumulator and the state of charge of the second accumulator are kept within the same range that is any one of the charge-and-discharge ranges, the one or more processors are configured to,
when the difference between the first accumulated amount of discharge and the second accumulated amount of discharge in the same range is greater than the amount-of-discharge threshold value, and the first accumulated amount of discharge is smaller than the second accumulated amount of discharge in the same range,
change the powering torque distribution ratio between the first travel motor and the second travel motor from the reference distribution ratio,
thereby increasing the powering torque to be allocated to the first travel motor to a greater value than the powering torque to be allocated based on the reference distribution ratio, and reducing the powering torque to be allocated to the second travel motor to a smaller value than the powering torque to be allocated based on the reference distribution ratio.

8. The vehicle control apparatus according to claim 2, wherein
a segment between a lower limit state of charge and an upper limit state of charge in the first accumulator and the second accumulator is separated into charge-and-discharge ranges,
the one or more processors are configured to
accumulate a discharge current of the first accumulator for each of the charge-and-discharge ranges, to calculate a first accumulated amount of discharge, and
accumulate a discharge current of the second accumulator for each of the charge-and-discharge ranges, to calculate a second accumulated amount of discharge,
in a state in which the state of charge of the first accumulator and the state of charge of the second accumulator are kept within a same range that is any one of the charge-and-discharge ranges, the one or more processors are configured to,
when a difference between the first accumulated amount of discharge and the second accumulated amount of discharge in the same range is greater than an amount-of-discharge threshold value, and the first accumulated amount of discharge is greater than the second accumulated amount of discharge in the same range,
change the powering torque distribution ratio between the first travel motor and the second travel motor from the reference distribution ratio,
thereby reducing the powering torque to be allocated to the first travel motor to a smaller value than the powering torque to be allocated based on the reference distribution ratio, and increasing the powering torque to be allocated to the second travel motor to a greater value than the powering torque to be allocated based on the reference distribution ratio, and
in the state in which the state of charge of the first accumulator and the state of charge of the second accumulator are kept within the same range that is any one of the charge-and-discharge ranges, the one or more processors are configured to,
when the difference between the first accumulated amount of discharge and the second accumulated amount of discharge in the same range is greater than the amount-of-discharge threshold value, and the first accumulated amount of discharge is smaller than the second accumulated amount of discharge in the same range,
change the powering torque distribution ratio between the first travel motor and the second travel motor from the reference distribution ratio,
thereby increasing the powering torque to be allocated to the first travel motor to a greater value than the powering torque to be allocated based on the reference distribution ratio, and reducing the powering torque to be allocated to the second travel motor to a smaller value than the powering torque to be allocated based on the reference distribution ratio.

9. The vehicle control apparatus according to claim 3, wherein
a segment between a lower limit state of charge and an upper limit state of charge in the first accumulator and the second accumulator is separated into charge-and-discharge ranges,
the one or more processors are configured to
accumulate a discharge current of the first accumulator for each of the charge-and-discharge ranges, to calculate a first accumulated amount of discharge, and
accumulate a discharge current of the second accumulator for each of the charge-and-discharge ranges, to calculate a second accumulated amount of discharge,
in a state in which the state of charge of the first accumulator and the state of charge of the second accumulator are kept within a same range that is any one of the charge-and-discharge ranges, the one or more processors are configured to,
when a difference between the first accumulated amount of discharge and the second accumulated amount of discharge in the same range is greater than an amount-of-discharge threshold value, and the first accumulated amount of discharge is greater than the second accumulated amount of discharge in the same range,
change a powering torque distribution ratio between the first travel motor and the second travel motor from the reference distribution ratio,
thereby reducing powering torque to be allocated to the first travel motor to a smaller value than powering torque to be allocated based on the reference distribution ratio, and increasing powering torque to be allocated to the second travel motor to a greater value than powering torque to be allocated based on the reference distribution ratio, and
in the state in which the state of charge of the first accumulator and the state of charge of the second accumulator are kept within the same range that is any one of the charge-and-discharge ranges, the one or more processors are configured to,
when the difference between the first accumulated amount of discharge and the second accumulated amount of discharge in the same range is greater than the amount-of-discharge threshold value, and the first accumulated amount of discharge is smaller than the second accumulated amount of discharge in the same range,
change the powering torque distribution ratio between the first travel motor and the second travel motor from the reference distribution ratio,
thereby increasing the powering torque to be allocated to the first travel motor to a greater value than the powering torque to be allocated based on the reference distribution ratio, and reducing the powering torque to be allocated to the second travel motor to a smaller value than the powering torque to be allocated based on the reference distribution ratio.
